(19) United States
(12) Patent Application Publication
(10) Pub. No.: US 2011/0276823 A1
(43) Pub. Date: Nov. 10, 2011

(54) INFORMATION PROCESSING APPARATUS, BACKUP SERVER AND BACKUP SYSTEM

(75) Inventors: Kaoru Ueno, Kawasaki (JP); Tomohiro Ubukata, Kawasaki (JP); Kenta Hara, Kawasaki (JP)

(73) Assignee: FUJITSU LIMITED, Kawasaki-shi (JP)

(21) Appl. No.: 13/091,820

(22) Filed: Apr. 21, 2011

(30) Foreign Application Priority Data
May 7, 2010 (JP) 2010-107748

(51) Int. Cl. G06F 11/20

(52) U.S. Cl. 714/4.11; 714/E11.073

(57) ABSTRACT

An information processing apparatus includes a backup data storage unit, a monitoring information storage unit and a backup data transfer unit. The backup data storage unit stores backup data. The monitoring information storage unit stores monitoring information that includes at least identification information and priority information of the backup data. The backup data transfer unit transfers the backup data to a backup server via a network in response to a transfer request for the backup data. The transfer request is received from the backup server on the basis of the priority information of the monitoring information which is notified to the backup server from the information processing apparatus.

### CROSS-REFERENCE TO RELATED APPLICATIONS

This application is based upon and claims the benefit of priority from the prior Japanese Patent Application No. 2010-107748 filed on May 7, 2010, the entire contents of which are incorporated herein by reference.

### FIELD

The present embodiments relate to a technology for backing up backup data or restoring it. For example, the present embodiments relate to an information processing apparatus utilizing a backup server connected via a network, the backup server, a backup method, and a backup system.

### BACKGROUND

As technology for saving backup data of an information processing apparatus, means utilizing a backup server connected via a network and means utilizing a storage device locally connected to the information processing apparatus are proposed. In a case where the thus saved backup data is restored in the information processing apparatus, transfer of the backup data from the backup server to the information processing apparatus or reading of the backup data from the storage device of the information processing apparatus is carried out.

With regard to the above-mentioned saving and restore of the backup data, for example, Japanese Unexamined Patent Application Publication No. 2005-284842 discloses a technology in which a terminal apparatus performs a backup operation in a background of a normal operation, and then, the terminal apparatus and a backup server connected to a network transmit and receive backup data while breaking up the backup data into a predetermined size. Japanese Unexamined Patent Application Publication (Translation of PCT Application) No. 2003-536157 discloses a backup system provided with a storage device that stores a log entry of backup data, in which backup is carried out in the storage device in a case where network traffic is low. Japanese Unexamined Patent Application Publication (Translation of PCT Application) No. 2007-523392 discloses a local backup and a remote backup. Japanese Unexamined Patent Application Publication No. 2009-205548 discloses a backup system adapted to save backup data in a storage device via a network. The backup system is provided with load reduction means for a backup processing, and a backup list is created.

### SUMMARY

According to an embodiment, an information processing apparatus includes a backup data storage unit, a monitoring information storage unit and a backup data transfer unit. The backup data storage unit stores backup data. The monitoring information storage unit stores monitoring information that includes at least identification information and priority information of the backup data. The backup data transfer unit transfers the backup data to a backup server via a network in response to a transfer request for the backup data. The transfer request is received from the backup server on the basis of the priority information of the monitoring information which is notified to the backup server from the information processing apparatus.

The object and advantages of the various embodiments will be realized and attained by means of the elements and combinations particularly pointed out in the claims. It is to be understood that both the foregoing general description and the following detailed description are exemplary and explanatory and are not restrictive of the various embodiments, as claimed.

Additional aspects and/or advantages will be set forth in part in the description which follows and, in part, will be apparent from the description, or may be learned by practice of the various embodiments.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates a configuration example of an information processing apparatus according to a first embodiment;

FIG. 2 is a flow chart illustrating an example of a backup processing in an information processing apparatus;

FIG. 3 illustrates a configuration example of a backup server according to a second embodiment;

FIG. 4 is a flow chart illustrating an example of a backup processing in a backup server;

FIG. 5 illustrates a configuration example of a backup system according to a third embodiment;

FIG. 6 illustrates a processing example of obtaining respective apparatus information to create an apparatus information table;

FIG. 7 illustrates an exemplary apparatus information table;

FIG. 8 illustrates a configuration example of a collection processing for a backup target information table;

FIG. 9 illustrates an example of the backup target information table;

FIG. 10 illustrates an exemplary backup queue;

FIG. 11 is a sequence diagram illustrating an example of a backup transfer processing between a backup server and an information processing apparatus side;

FIG. 12 illustrates a hardware configuration example of an information processing apparatus;

FIG. 13 illustrates an exemplary personal computer (PC);

FIG. 14 illustrates a hardware configuration example of a backup server;

FIG. 15 illustrates an exemplary apparatus information table;

FIG. 16 illustrates an exemplary apparatus information table;

FIG. 17 illustrates an example of a backup target information table which is notified to a backup server;

FIG. 18 illustrates an exemplary backup queue;

FIG. 19 illustrates a configuration example of a backup system in a case where a warning occurs in failure information of an information processing apparatus;

FIG. 20 illustrates an exemplary backup queue;

FIG. 21 is a flow chart illustrating obtainment of monitoring information and an example of a data transfer preparation processing in an information processing apparatus;

FIG. 22 is a flow chart illustrating an example of a data transfer preparation processing in a backup server;

FIG. 23 is a flow chart illustrating an example of a data backup processing in an information processing apparatus;

FIG. 24 is a flow chart illustrating an example of a backup data transfer processing in a backup server;

FIG. 25 illustrates a configuration example for executing a restore of data from backup data stored in an information processing apparatus;

FIG. 26 is a sequence diagram illustrating an example of a restore processing of data using a backup data stored in an information processing apparatus;

FIG. 27 illustrates a configuration example for a restore processing of a system based on backup data in a data segment of an information processing apparatus;

FIG. 28 illustrates a sequence example of the restore processing of a system based on a backup data in a data segment of an information processing apparatus;

FIG. 29 illustrates a configuration example for a restore processing of a system based on backup data stored in a backup server;

FIG. 30 illustrates a sequence example of the restore processing of the system based on a backup data stored in a backup server;

FIG. 31 is a flow chart illustrating an example of a restore processing in a backup server;

FIG. 32 is a flow chart illustrating an example of a restore processing in an information processing apparatus;

FIG. 33 illustrates a network type backup system in a comparison example;

FIG. 34 illustrates a stand alone type backup system in a comparison example;

FIG. 35 illustrates an exemplary mobile phone device according to another embodiment; and

FIG. 36 illustrates an exemplary PDA according to another embodiment.

### DETAILED DESCRIPTION OF THE EMBODIMENTS

[First Embodiment]

A first embodiment relates to an information processing apparatus connected to a backup server via a network. This information processing apparatus stores backup data such as function data for executing an information processing function in a storage device locally connected to the information processing apparatus and transfers the backup data to the backup server on the network. This transfer to the backup server is carried out in accordance with a transfer request based on priority information of the backup data.

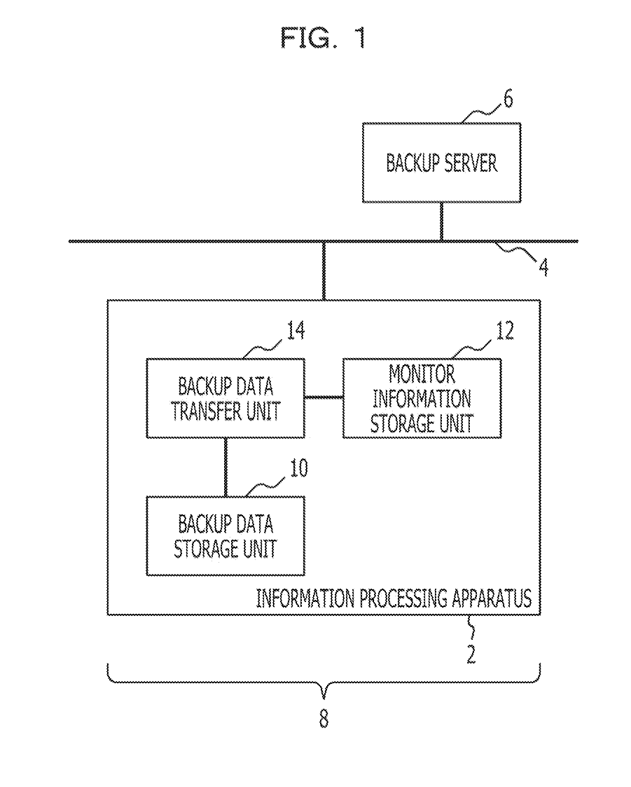

With regard to the first embodiment, a reference is made to FIG. 1. FIG. 1 illustrates a configuration example of an information processing apparatus according to a first embodiment. It should be noted that the configuration illustrated in FIG. 1 is an example and is not limited to this.

The information processing apparatus 2 is an example of the information processing apparatus disclosed in the present application. The information processing apparatus 2 is connected to a backup server 6 via the network 4. The information processing apparatus 2 constitutes a backup system 8 in which backup data is transferred and kept in the backup server 6. The backup system 8 is an example of a backup system according to the present disclosure. The backup data is function data or the like of the information processing apparatus 2 and includes, for example, OS (Operating System) data, an application program, other function setting program data, and the like.

The information processing apparatus 2 is constituted by a computer. The information processing apparatus 2 is, for example, a personal computer, a mobile phone apparatus, a server apparatus, or the like. The information processing apparatus 2 is connected to a network such as an in-house LAN (Local Area Network) or the internet. The information processing apparatus 2 includes, as illustrated in FIG. 1, for example, a backup data storage unit 10, a monitoring information storage unit 12, and a backup data transfer unit 14.

The backup data storage unit 10 is an example of means for storing the backup data accumulated in the information processing apparatus 2. The backup data storage unit 10 is, for example, a storage device such as a hard disk drive (HDD). As described above, the information processing apparatus 2 keeps the backup data in the backup server 6 and stores the backup data in the storage unit 10. The information processing apparatus 2 constitutes a hybrid type backup system where a local backup function and a network backup function are used in combination.

The monitoring information storage unit 12 is an example of means for storing the backup data and monitoring information of the information processing apparatus 2. The monitoring information includes identification information including at least a type of the backup data, data size information, and the like, for example, importance information set by a user, or priority information or the like automatically set in the information processing apparatus 2. The monitoring information is obtained, for example, at the time of the backup processing execution. When the backup server 6 is notified of this monitoring information, the backup server 6 generates transfer order information and transmits a transfer request of the backup data to the information processing apparatus 2.

The backup data transfer unit 14 is an example of means for transferring the backup data from the information processing apparatus 2 via the network 4 to the backup server 6. As described above, upon reception of the transfer request from the backup server 6, the backup data transfer unit 14 reads out the backup data stored in the backup data storage unit 10 to be transferred to the backup server 6. This data transfer processing may be executed, for example, in a background processing of a normal operation by the information processing apparatus 2.

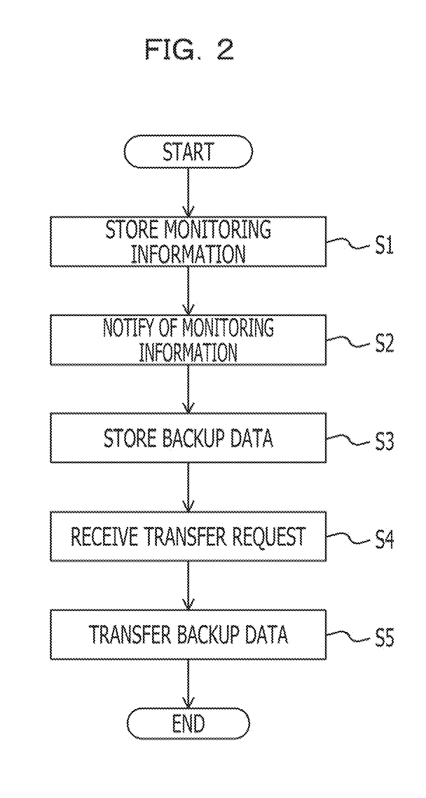

With regard to this backup processing in the information processing apparatus 2, a reference is made to FIG. 2. FIG. 2 is a flow chart illustrating an example of the backup processing in the information processing apparatus.

This backup processing is an example of the backup processing disclosed in the present application. First, the information processing apparatus 2 obtains the monitoring information (for example, including the identification information and the priority information of the backup data described above, and the like) and stores the above-mentioned monitoring information in the monitoring information storage unit 12 (Operation S1). And, the information processing apparatus 2 notifies the backup server 6 of the monitoring information obtained at this time (Operation S2).

Next, the information processing apparatus 2 stores the backup data in the backup data storage unit 10 as local backup (Operation S3). When the transfer request from the backup server 6 is received (Operation S4), the information processing apparatus 2 transfers the requested backup data to the backup server 6 (Operation S5). This reception of the transfer request (Operation S4) and the transfer of the backup data (Operation S5) are repeatedly executed while all pieces of the backup data in the above-mentioned information processing apparatus 2 are set as targets, and thereafter, the backup processing is ended.

According to the above-mentioned embodiment, in accordance with the transfer instruction from the backup server based on the set transfer order, the backup data is transferred to the backup server. According to this configuration, the load on the network channel is alleviated. And, the transfer order of the backup data is set on the basis of the priority or the like of the backup data. According to this configuration, the backup of the data having the high importance is prioritized, and the reliability of the backup function is enhanced.

[Second Embodiment]

A second embodiment relates to a backup server connected to one or a plurality of information processing apparatuses on a network.

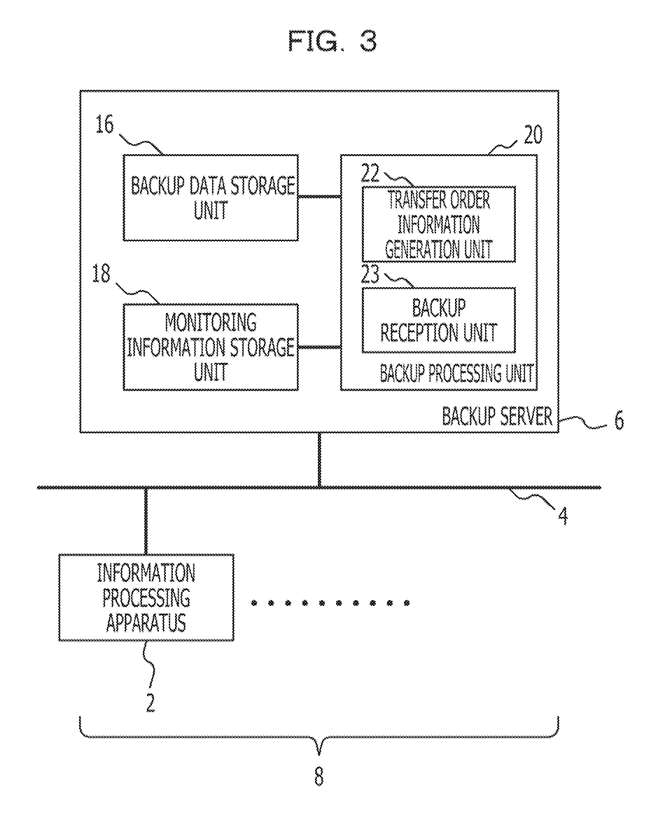

With regard to the second embodiment, a reference is made to FIG. 3. FIG. 3 illustrates a functional configuration example of a backup server according to the second embodiment. It should be noted that the configuration of the backup server illustrated in FIG. 3 is an example and is not limited to this. In FIG. 3, the same reference symbols are assigned to the same components as those in FIG. 1.

The backup server 6 is an example of a backup server or a backup system disclosed in the present application. As described above, the backup server 6 is an apparatus that stores the backup data of one or a plurality of the information processing apparatuses 2 connected on the network. The backup server 6 is provided, as illustrated in FIG. 3, for example, with a backup data storage unit 16, a monitoring information storage unit 18, and a backup processing unit 20.

The backup data storage unit 16 is an example of means for storing the backup data transferred from the information processing apparatus 2. The backup data storage unit 16 is, for example, a storage device such as a hard disk drive (HDD). The backup data stored in the backup data storage unit 16 includes, for example, identification information with which it is possible to distinguish the information processing apparatus 2. The backup data storage unit 16 may divide storage sections for each information processing apparatus 2 that is a backup target.

The monitoring information storage unit 18 is an example of means for storing the backup data and the monitoring information of the information processing apparatus 2. The monitoring information storage unit 18 includes the above-mentioned monitoring information notified from the respective information processing apparatuses 2. The monitoring information includes, for example, apparatus information for identifying the information processing apparatus that is the backup target, identification information and priority information of the backup data, and the like. The identification information of the respective information processing apparatuses 2 and the backup data stored in the backup data storage unit 16 are associated with each other.

The backup processing unit 20 is an example of means for executing a transform processing of the backup data between the information processing apparatuses 2. The backup processing unit 20 is provided with a transfer order information generation unit 22. The transfer order information generation unit 22 receives the respective pieces of the monitoring information notified from the respective information processing apparatuses 2. Additionally, the transfer order information generation unit 22 generates transfer order information in which a transfer order for each backup data is set. The transfer order information of the backup data includes, for example, priority information taking into account the importance set in the respective pieces of the backup data, priority information on the information processing apparatus 2 that stores the backup data, and the like. On the basis of the transfer order information, the backup processing unit 20 transmits a transfer request to the respective information processing apparatuses 2. Then, a backup reception unit 23 receives the backup data transferred from the respective information processing apparatuses 2 that respond to the transfer request.

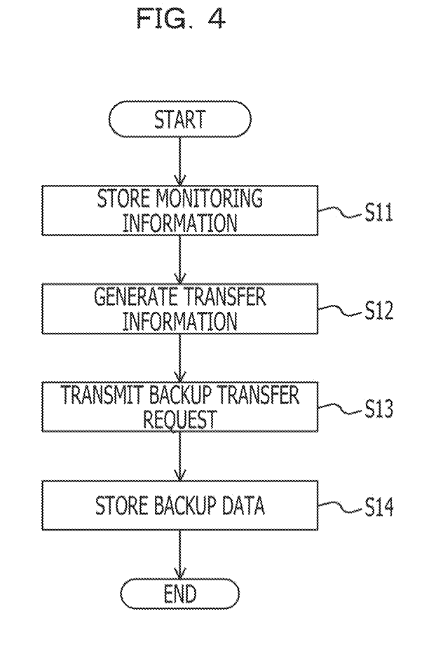

Next, with regard to the backup processing in the backup server 6, a reference is made to FIG. 4. FIG. 4 is a flow chart illustrating an example of a backup processing in the backup server.

This backup processing is an example of a backup method disclosed in the present application. First, the backup server 6 receives the monitoring information notified from the respective information processing apparatuses 2 and stores the above-mentioned monitoring information in the monitoring information storage unit 18 (Operation S11). On the basis of this monitoring information, the backup server 6 generates the transfer order information in which the transfer order for each backup data stored in the respective information processing apparatuses 2 is set (Operation S12).

Then, as a transfer stage of the backup data, the backup server 6 transmits a backup transfer request to the information processing apparatus 2 that stores the backup data on the basis of the transfer order information (Operation S13). In accordance with this transfer request, the backup server 6 receives the backup data from the information processing apparatus 2 and stores the backup data in the backup data storage unit 16 (Operation S14). At this time, as described above, the transferred backup data may be linked to the monitoring information of the monitoring information storage unit 18. The backup server 6 executes the transmission of the transfer request (Operation S13) and the storage of the backup data (Operation S14) for all the pieces of the backup data indicated by the transfer order information.

According to the above-mentioned embodiment, with respect to the plurality of information processing apparatuses having the backup data, on the backup server side, the control on the transfer order for each backup data is carried out. According to this configuration, the load on the network channel is alleviated and the transfer order is set on the basis of the priority or the like of the backup data. According to this configuration, the backup of the data having the high importance is prioritized, and the reliability of the backup function is enhanced.

[Third Embodiment]

A third embodiment relates to a backup processing in a backup system connected in which a plurality of information processing apparatuses are connected.

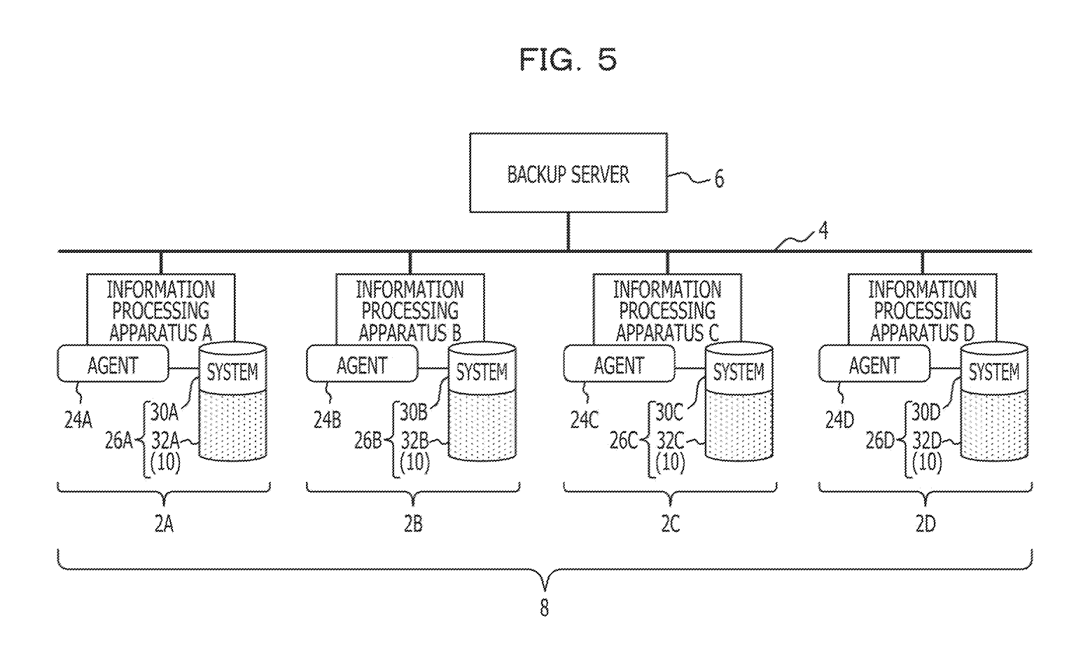

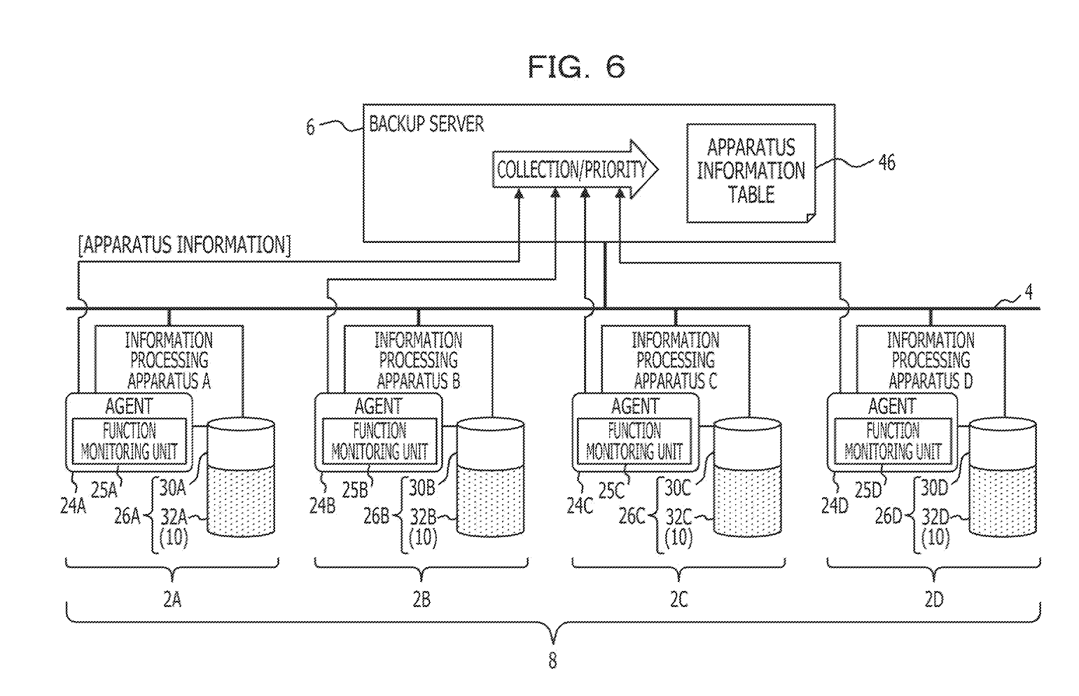

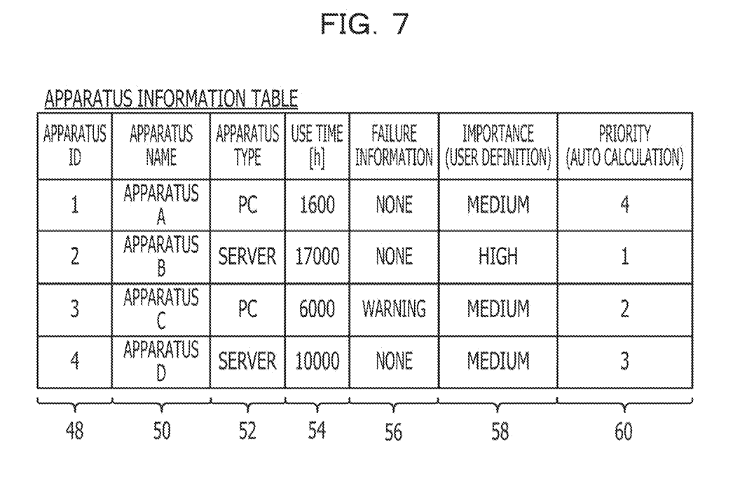

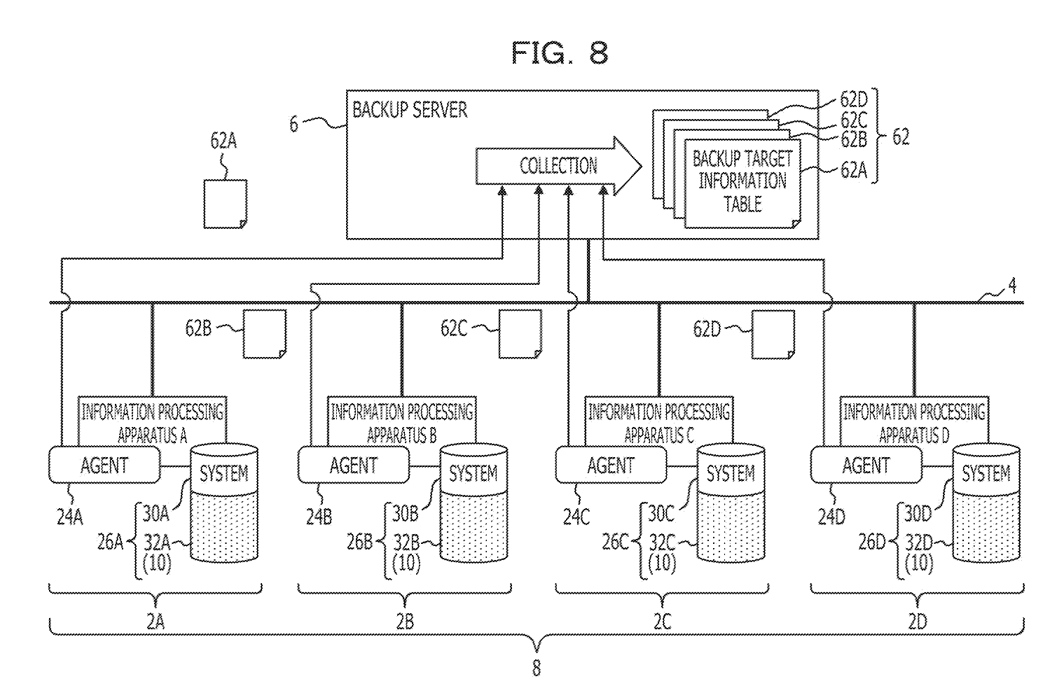

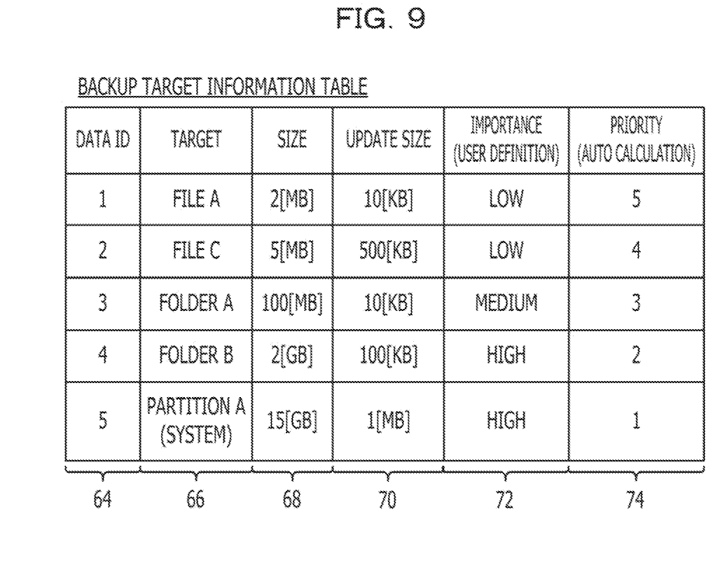

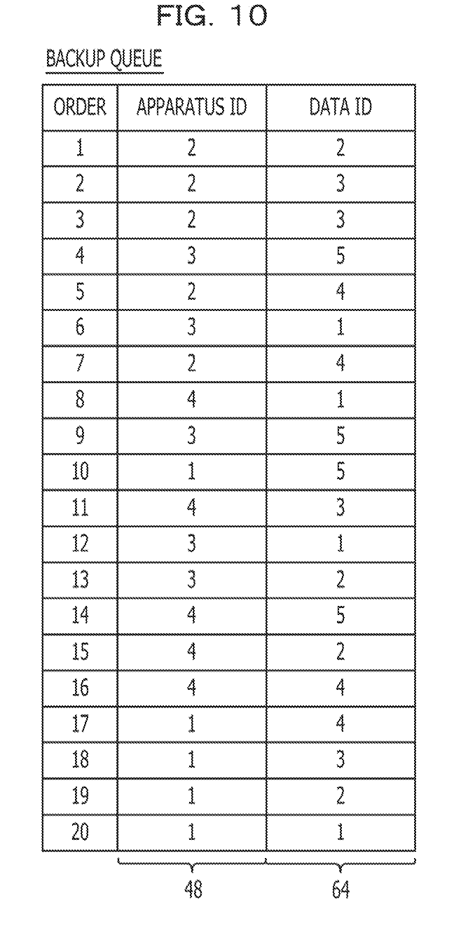

With regard to the third embodiment, a reference is made to FIG. 5, FIG. 6, FIG. 7, FIG. 8, FIG. 9, and FIG. 10. FIG. 5 illustrates a configuration example of the backup system. FIG. 6 illustrates a processing example of obtaining respective apparatus information to create an apparatus information table. FIG. 7 illustrates an exemplary apparatus information table. FIG. 8 illustrates an example of a collection processing of a backup target information table. FIG. 9 illustrates an example of the backup target information table. FIG. 10 illustrates an exemplary backup queue. It should be noted that configurations illustrated in FIG. 5, FIG. 6, FIG. 7, FIG. 8, FIG. 9, and FIG. 10 are examples and are not limited to these.

As described above, the backup system 8 includes a plurality of information processing apparatuses 2A, 2B, 2C, and 2D and the backup server 6 which are connected via the network 4. The respective information processing apparatuses 2A, 2B, 2C, and 2D are provided with agent programs 24A, 24B, 24C, and 24D for performing an obtaining control on each apparatus information and a backup control, for example. The agent programs 24A, 24B, 24C, and 24D executes, for example, processings for the collection of the apparatus information, the collection of the backup target information, and the priority setting, and a processing for transmitting those pieces of information to the backup server 6. The agent programs 24A, 24B, 24C, and 24D are used for performing determination on a restore execution of the backup data and transmission and reception of an execution instruction which will be described below and constitute a function monitoring unit 25 for obtaining the monitoring information and the above-mentioned backup data transfer unit 14, for example, in the information processing apparatus 2.

The information processing apparatuses 2A, 2B, 2C, and 2D are provided with data storage devices 26A, 26B, 26C, and 26D that store data and the like. The data storage devices 26 of the information processing apparatus 2 include, for example, system sections 30A, 30B, 30C, and 30D that store system data for causing the information processing apparatus 2 to function. The data storage devices 26 includes data sections 32A, 32B, 32C, and 32D in addition to the areas for the system sections 30A, 30B, 30C, and 30D. The data section 32 functions as the above-mentioned backup data storage unit 10.

In the above-mentioned configuration, as illustrated in FIG. 6, the agent programs 24A to 24D obtain the apparatus information on each of the information processing apparatuses 2A to 2D through the function monitoring. The respective pieces of the apparatus information include, for example, the identification information, type information, use time, failure information, importance of the information processing apparatuses 2A to 2D, and the like. The agent programs 24A to 24D notify the backup server 6 of the obtained apparatus information. In the backup server 6, an apparatus information table 46 for the information processing apparatuses 2A to 2D that request the backup is generated. The apparatus information table 46 includes the priority information with respect to the respective information processing apparatuses 2A to 2D assigned by the backup server 6.

The apparatus information table 46 includes, for example, as illustrated in FIG. 7, apparatus ID information 48, apparatus name information 50, apparatus type information 52, use time information 54, failure information 56, importance information 58, and priority information 60.

A setting on the priority information 60 by the backup server 6 will be described.

The backup server 6 refers to the importance information 58 set in the respective pieces of the apparatus information and performs a priority setting in the descending order of the importance. The importance may be arbitrarily set, for example, by users of the respective information processing apparatuses 2A to 2D. The setting on the importance may be changed each time the backup is executed. For example, the respective agent programs 24A to 24D may change the importance in accordance with the volume of the data amount to be updated. And, in a case where the importance information is omitted, for example, default setting information previously set by the user may be utilized for the setting on the importance.

In a case where the set importance is the same, for example, the backup server 6 may refer to the failure information 56, and the setting may be performed in the order of a probability for the failure (for example, “warning”, “attention”, and “none”).

In a case where the failure information 56 is also the same, for example, the backup server 6 may refer to the use time information 54, and the setting may be performed in the descending order of the use time.

In a case where the use time information 54 is also the same, for example, the backup server 6 may refer to the apparatus type information 52, and the setting may be performed in the of “server” and “PC”.

The priority is set while following the above-mentioned criteria. Then, this information is stored in the storage device and the like of the backup server 6 as the monitoring information.

Next, as illustrated in FIG. 8, the respective agent programs 24A to 24D generate backup target information table 62A to 62D of the respective information processing apparatuses 2A to 2D to notify the backup server 6 side thereof. The backup target information table 62A to 62D include, for example, as illustrated in FIG. 9, data ID information 64, target information 66, size information 68, update size information 70, importance information 72, and priority information 74.

It should be noted that FIG. 9 illustrates an example of the backup target information table 62A of the information processing apparatus 2A.

Herein, a setting on the priority information 74 in the backup target information table 62 will be described while the backup target information table 62A of the information processing apparatus 2A is exemplified.

The priority information 74 in the backup target information table 62A is set, for example, by the agent program 24A. The agent program 24A refers to the importance information 72 for each backup data set by the user of the information processing apparatus 2A and sets the information in the descending order of the importance as the priority information 74.

In a case where the importance is omitted, the agent program 24A may set the priority on the basis of the importance information previously set for each data. In a case where the importance information 72 is the same, for example, the agent program 24A may refer to the update size information 70 and may be set the higher priority in the descending order of the update side. Furthermore, in a case where the update size is the same, the agent program 24A may refer to the size information 68 of the data and may be set the higher priority in the ascending order of the size of the data.

The priority of the backup target information is set in the above-mentioned criteria. Then, the agent program 24A stores the backup target information table 62A in the storage device or the like of the backup server 6 as the monitoring information.

When the apparatus information table 46 and the respective backup target information tables 62 are obtained as described above, the backup server 6 sets a transfer order with respect to the backup data in the information processing apparatuses 2A to 2D as an execution preparation for the backup processing. The backup server 6 creates a backup queue 78 as this transfer order information, for example, as illustrated in FIG. 10. The backup queue 78 is an example of the backup transfer order information. The backup queue 78 regulates a schedule for transmitting the backup transfer request.

In the backup queue 78, for example, while the order information is used as a reference, the apparatus ID information 48 and the data ID information 64 are set. That is, the backup queue 78 is managed by the apparatus ID information 48 of the apparatus information table 46 and the data ID information 64 of the backup target information table 62.

Examples of the criteria used when the backup queue 78 is created from the contents of the apparatus information table 46 and the backup target information table 62 obtained by the backup server 6 will be described.

The backup server 6 sequentially creates the backup queue 78 from 1 in the order from the “high” to “low” of the importance of the apparatus information table 46, 1. At this time, in a case where the importance is the same, with regard to the monitoring target apparatus (information processing apparatus) except for “warning”, the backup server 6 stores one backup target having the high priority from the backup target information table 62 of the monitoring target apparatus having the high priority in the backup queue 78. Then, the backup server 6 stores one backup target having the high priority from the backup target information table 62 of the monitoring target apparatus having the next higher priority in the backup queue 78. The backup server 6 repeatedly performs this processing until the backup target does not exist.

On the basis of the backup queue 78 created on the basis of the above-mentioned criteria, the backup server 6 transmits the transfer request to the information processing apparatus and executes the backup processing.

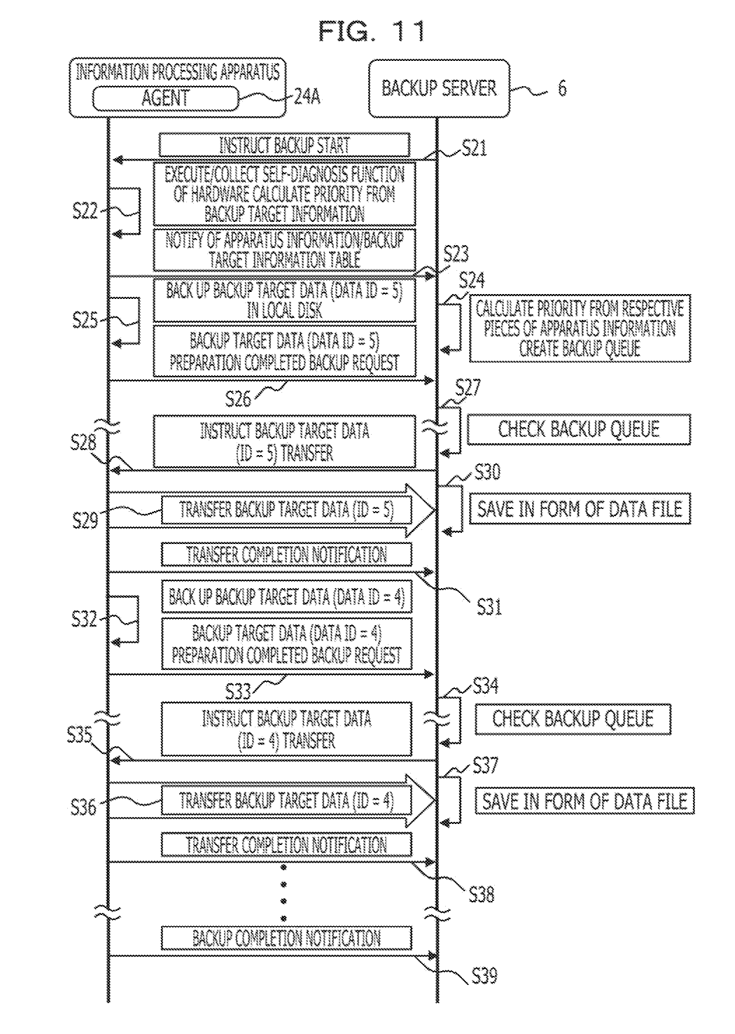

Next, with regard to a transfer processing for the backup data, a reference is made to FIG. 11. FIG. 11 is a sequence diagram illustrating an example of a backup transfer processing between the backup server and the information processing apparatus side. It should be noted that the processing procedure and the processing content illustrated in FIG. 11 are examples and are not limited to these.

In this transfer processing for the backup data, as illustrated in FIG. 11, only the transfer processing between the backup server 6 and the agent program 24A of the information processing apparatus 2A is illustrated. Also with regard to the respective information processing apparatuses 2B to 2D connected to the backup server 6, a sequence processing similar to the transfer processing is carried out, but in the following description, the processing related to the information processing apparatuses 2B to 2D is omitted.

This transfer processing for the backup data is an example of a backup program and a backup method according to the present disclosure. Through this transfer processing for the backup data, backup transfer order information is generated on the basis of the apparatus information notified from the respective information processing apparatuses 2A to 2D, the identification information of the backup data, and the like. On the basis of the backup transfer order information, the backup server 6 transmits transfer instructions to the respective information processing apparatuses 2A to 2D. The transfer of the backup data is carried out in accordance with this transfer instruction.

A backup start instruction is transmitted from the backup server 6 to the information processing apparatus 2A (Operation S21). The information processing apparatus 2A executes a self-diagnosis function of the hardware upon the reception of this start instruction, performs collection of apparatus information, and performs setting on the priority on the basis of the backup target information (Operation S22). As described above, the collection of apparatus information and the setting on the priority are performed by the agent program 24A. The information processing apparatus 2A notifies the backup server 6 of the obtained apparatus information and the backup target information table 62A (Operation S23). As illustrated in FIG. 6 and FIG. 8, the backup server 6 creates the apparatus information table 46 from the apparatus information notified from the respective information processing apparatuses 2A to 2D, performs the setting on the priority, and creates the backup queue 78 (Operation S24).

The information processing apparatus 2A stores the backup data having the data ID=5 which is the highest in priority in the data section 32A of the data storage device 26A while following the priority of the backup target information table 62A (FIG. 9) and executes a local backup (Operation S25). When the local backup of the backup data having the data ID=5 is completed, the information processing apparatus 2A transmits a backup request of the data having the data ID=5 to the backup server 6 (Operation S26). When the backup server 6 receives this backup request, the backup server 6 checks the backup queue 78 (Operation S27).

In this case, for the data ID=5 of the apparatus ID=1 that performs the backup request (the information processing apparatus 2A), the transfer order is the tenth as illustrated in FIG. 10. The data having the data ID=5 is put into a transfer standby state until this transfer order arrives. When the transfer processings by the other information processing apparatuses 2B to 2D which are not illustrated, that is, the transfer processings whose transfer orders are from one to nine are completed, the information processing apparatus 2A is notified of the transfer instruction of the data having the data ID=5 from the backup server 6 (Operation S28). When the backup data having the data ID=5 is transferred from the information processing apparatus 2A to the backup server 6 in accordance with this transfer instruction (Operation S29), this backup data having the data ID=5 is saved in the backup data storage unit 16 of the backup server 6 to be put into a data file (Operation S30). When the transfer of the backup data having the data ID=5 is completed, the information processing apparatus 2A transmits a completion notification to the backup server 6 (Operation S31).

Next, the transfer processing shifts to the backup processing for the data having the data ID=4 which is the next highest priority on the basis of the backup target information table 62A of the information processing apparatus 2A.

Similarly as described above, the information processing apparatus 2A performs the local backup on the backup data having the data ID=4 (Operation S32) and performs a backup request to the backup server 6 (Operation S33). The backup server 6 refers to the backup queue 78 and checks that the apparatus ID=1 and the data having the data ID=4 are the 17th transfer order (Operation S34). Then, when this data transfer order arrives, the backup server 6 notifies the information processing apparatus 2A of the transfer instruction of the data having the data ID=4 that is the backup target (Operation S35), and while using this as a trigger, the information processing apparatus 2A transfers the backup data having the data ID=4 to the backup server 6 (Operation S36). When the backup data having the data ID=4 is received, the backup server 6 saves the backup data in the backup data storage unit 16 to be put into a data file (Operation S37). When this transfer of the backup data having the data ID=4 is completed, the information processing apparatus 2A transmits the notification on that effect to the backup server 6 (Operation S38).

When the above-mentioned backup request and the transfer processing are repeatedly performed and the transfer of all pieces of the backup data from the information processing apparatus 2A to the backup server 6 is completed, the information processing apparatus 2A notifies the backup server 6 of the backup processing completion notification (Operation S39), and this processing is ended.

According to the above-mentioned embodiment, the backup processing is performed in the transfer order based on the importance set for each data and each apparatus. With this configuration, for example, even when a situation occurs in which all the backups cannot be completed, the backup of the importance data is performed. And, as the backup data is transferred in accordance with the transfer instruction from the backup server based on the set transfer order, the load on the network channel is alleviated.

[Fourth Embodiment]

A fourth embodiment illustrates hardware configuration examples and respective processing contents of the information processing apparatus 2 and the backup server 6 constituting the backup system 8 and relates to an embodiment of the backup data transfer processing.

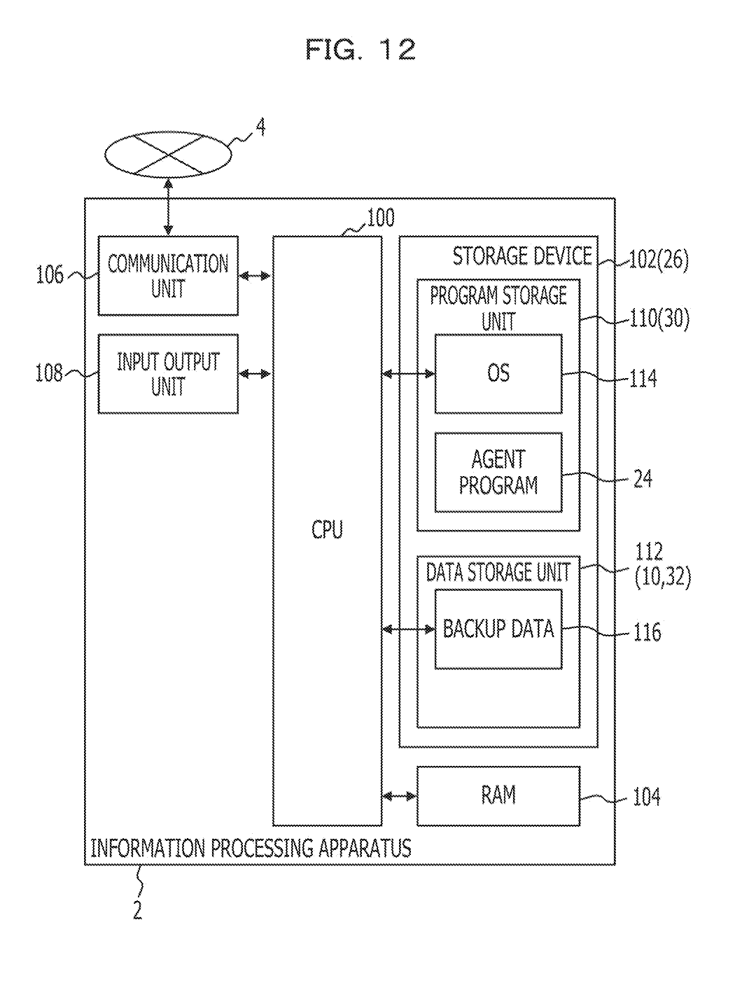

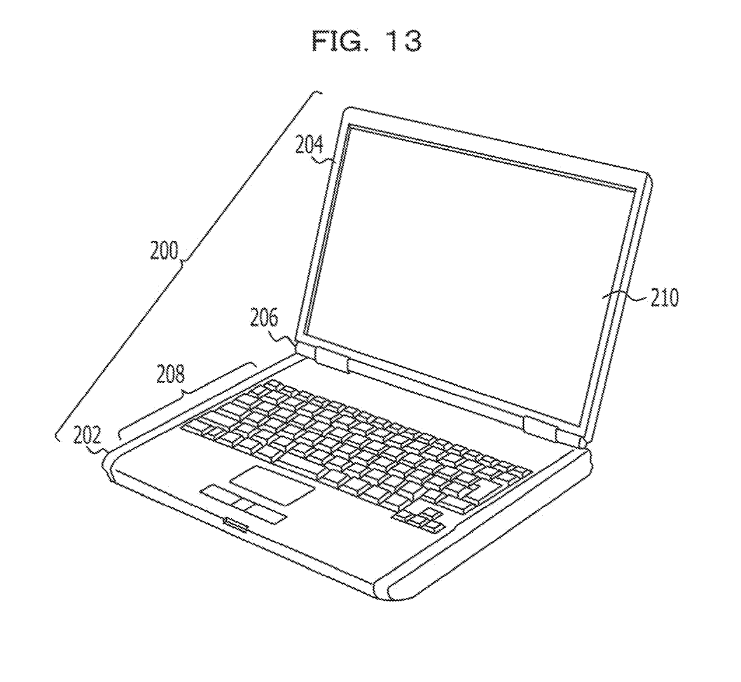

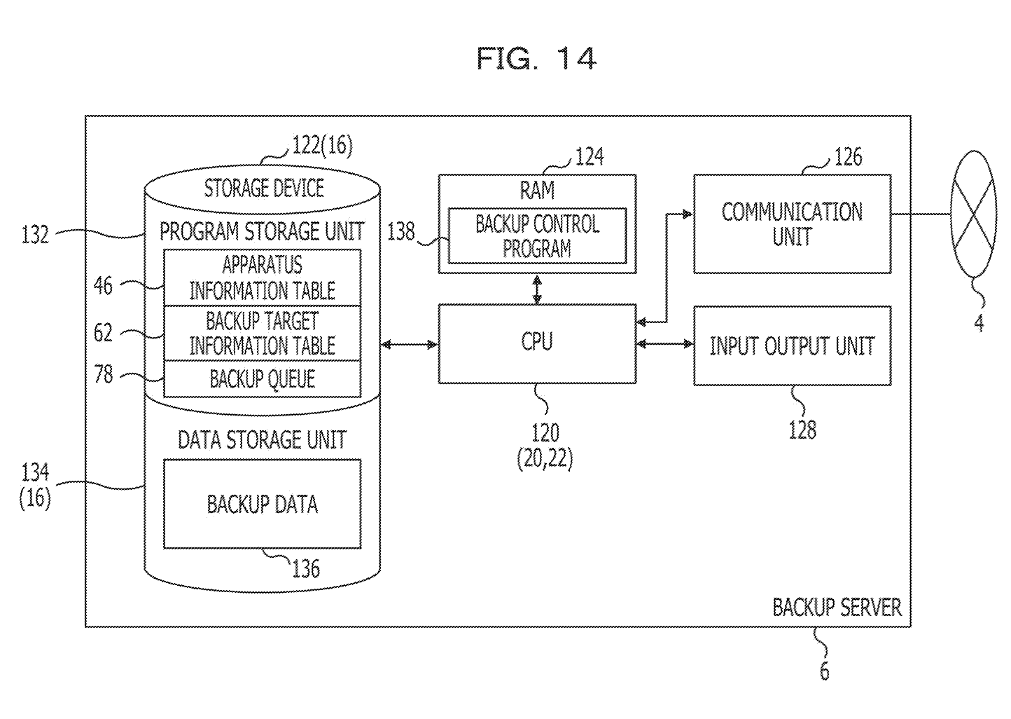

With regard to this fourth embodiment, a reference is made to FIG. 12, FIG. 13, and FIG. 14. FIG. 12 illustrates a hardware configuration example of the information processing apparatus. FIG. 13 illustrates an appearance of a PC. FIG. 14 illustrates a hardware configuration example of the backup server. It should be noted that the configurations illustrated in FIG. 12, FIG. 13, and FIG. 14 are examples and are not limited to these. In FIG. 12 and FIG. 14, the same parts are assigned with the same reference numerals as those in FIG. 1, FIG. 3, and FIG. 5.

The information processing apparatus 2 is an example of an information processing apparatus according to the present disclosure. The information processing apparatus 2 is provided with hardware for realizing the above-mentioned backup processing. The information processing apparatus 2 is provided, for example, with a CPU (Central Processing Unit) 100, a storage device 102, a RAM (Random Access Memory) 104, a communication unit 106, and an input output unit 108.

The CPU 100 is an example of computation means for executing an OS (Operating System) 114 that is stored in a program storage unit 110 of the storage device 102, the agent program 24, other control programs, and the like. The CPU 100 constitutes a control unit of the information processing apparatus 2. Then, by executing the agent program 24, as described above, the CPU 100 constitutes the function monitoring unit 25 that monitors the apparatus information on the information processing apparatus 2, the obtaining function for the monitoring information of the backup data, and the backup data transfer unit 14.

The storage device 102 is an example of storage means and recording means of the information processing apparatus 2. The storage device 102 is constituted by a hard disk drive (HDD) or the like. The storage device 102 corresponds, for example, to the above-mentioned data storage devices 26. The storage device 102 is constituted, for example, by the program storage unit 110 and a data storage unit 112. The program storage unit 110 corresponds to the system section 30 of the information processing apparatus 2, stores, for example, the OS 114 for performing an operation control, generation of the backup data, and the like and the above-mentioned agent program 24, and the like. The data storage unit 112 corresponds, for example, to the above-mentioned backup data storage unit 10 and the data section 32 and stores the data obtained by the information processing apparatus 2 and the like in addition to the backup data 116.

For the program storage unit 110 and the data storage unit 112, a hard disk drive (HDD) built in or externally connected to the information processing apparatus 2 is utilized. The program storage unit 110 and the data storage unit 112 may be constituted by a ROM, an EEPROM (Electrically Erasable and Programmable Read Only Memory) that can electrically change the content, or the like.

The above-mentioned agent program 24 and other control programs are not limited to ones stored in the program storage unit 110. For example, these programs may be recorded on a computer-readable recording medium such as a magnetic disk, a flexible disk, or an optical disk. Additionally, these programs may be ones stored in a server apparatus, a database, or the like on the network.

The RAM 104 constitutes a work area for executing the above-mentioned control programs and the like. The CPU 100 performs the above-mentioned backup control by executing the OS 114, the agent program 24, and the like while utilizing the RAM 104.

The communication unit 106 is an example of means for connecting the information processing apparatus 2 to the network 4. The communication unit 106 connects, for example, the information processing apparatus 2 to the backup server 6 or the like via the network 4 in a wireless or wired manner.

The input output unit 108 is an example of input means or output means with respect to the information processing apparatus 2. The input output unit 108 is, for example, a keyboard, a mouse, or the like and a monitor or the like. As described above, the input output unit 108 may be used for setting the importance, for example, with respect to the backup data and the apparatus and displaying the processing content of the information processing apparatus 2.

The information processing apparatus 2 is, for example, a PC 200 illustrated in FIG. 13. The PC 200 is an apparatus in which a keyboard side casing section 202 and a display side casing section 204 are coupled so as to be opened and closed by a hinge section 206. The keyboard side casing section 202 includes a keyboard 208 provided as an example of the input output unit 108. The display side casing section 204 includes an LCD (Liquid Crystal Display) 210. The LCD 210 is an example of the above-mentioned input output unit 108.

Next, FIG. 14 illustrates a hardware configuration example of the backup server 6.

The backup server 6 is an example of a backup server according to the present disclosure. The backup server 6 is provided with hardware for realizing the above-mentioned backup processing. The backup server 6 is provided, for example, with a CPU 120, a storage device 122, a RAM 124, a communication unit 126, an input output unit 128, and the like.

The CPU 120 is an example of computation means for executing an OS stored in the storage device 122, a backup control program, and the like. The CPU 120 constitutes the backup processing unit 20 and the transfer order information generation unit 22 as a control unit of the backup server 6. Then, by executing the backup control program, with respect to the apparatus information notified from the respective information processing apparatuses 2, the CPU 120 performs generation of the apparatus information table 46 where the priority is set with respect to the respective information processing apparatuses 2 and collection of the backup target information table 62. Then, the CPU 120 creates the backup queue 78 in which the transfer order information is set from these pieces of information and outputs the transfer request to the respective information processing apparatuses 2 on the basis of the transfer order for each backup data to perform the transfer control on the backup data.

The storage device 122 is an example of storage means or recording means of the backup server 6. The storage device 122 is constituted by the hard disk drive (HDD) or the like. The storage device 122 corresponds, for example, to the above-mentioned backup data storage unit 16. The storage device 122 is constituted, for example, by a program storage unit 132 and a data storage unit 134. The program storage unit 132 stores, for example, an OS, the backup control program, the apparatus information table 46, the backup target information table 62, the backup queue 78, and the like. The data storage unit 134 stores, for example, the backup data 136 transferred from the respective information processing apparatuses 2.

The program storage unit 132 and the data storage unit 134 utilize the hard disk drive (HDD) that is built in or externally connected to the backup server 6. The program storage unit 132 and the data storage unit 134 may be constituted by a ROM, an EEPROM that can electrically change the content, or the like.

The backup control program and other control programs are not limited to ones stored in the program storage unit 132. For example, these programs may be recorded on a computer-readable recording medium such as a magnetic disk, a flexible disk, or an optical disk. Additionally, these programs may be ones stored in another server apparatus, a database, or the like on the network.

The RAM 124 constitutes a work area for executing the above-mentioned control programs and the like. The CPU 120 performs the above-mentioned backup control by executing the OS, the backup control program 138, and the like while utilizing a RAM 123.

The communication unit 126 is an example of means for connecting the backup server 6 to the network 4. The communication unit 126 connects, for example, the backup server 6 to the respective information processing apparatuses 2 via the network 4 in a wireless or wired manner.

The input output unit 128 is an example of input means or output means with respect to the backup server 6. The input output unit 128 is, for example, a keyboard, a mouse, or the like and a monitor or the like.

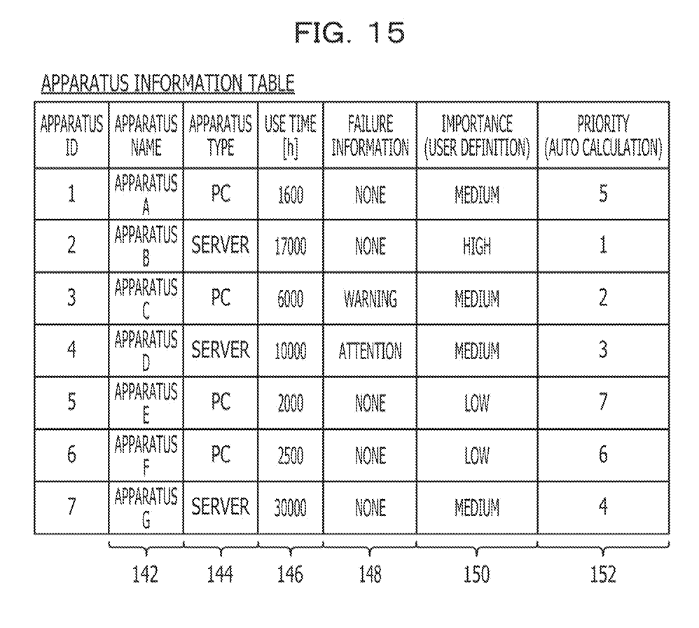

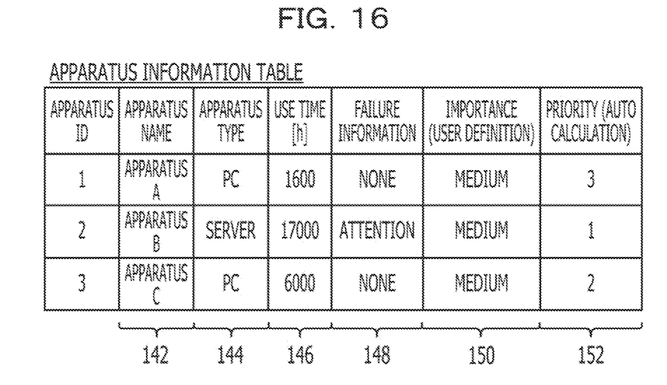

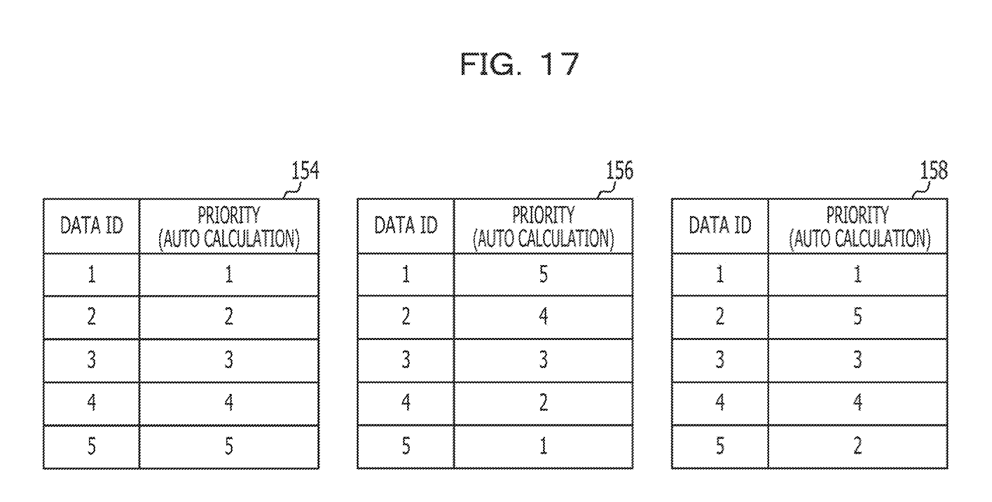

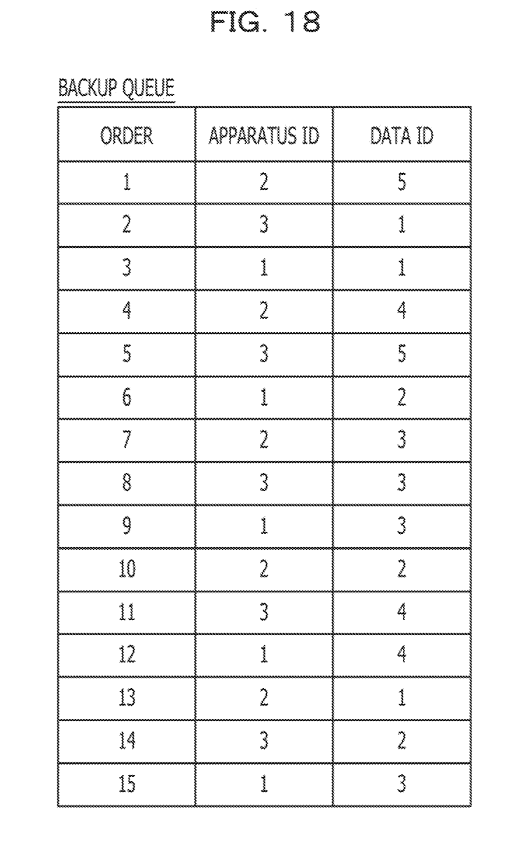

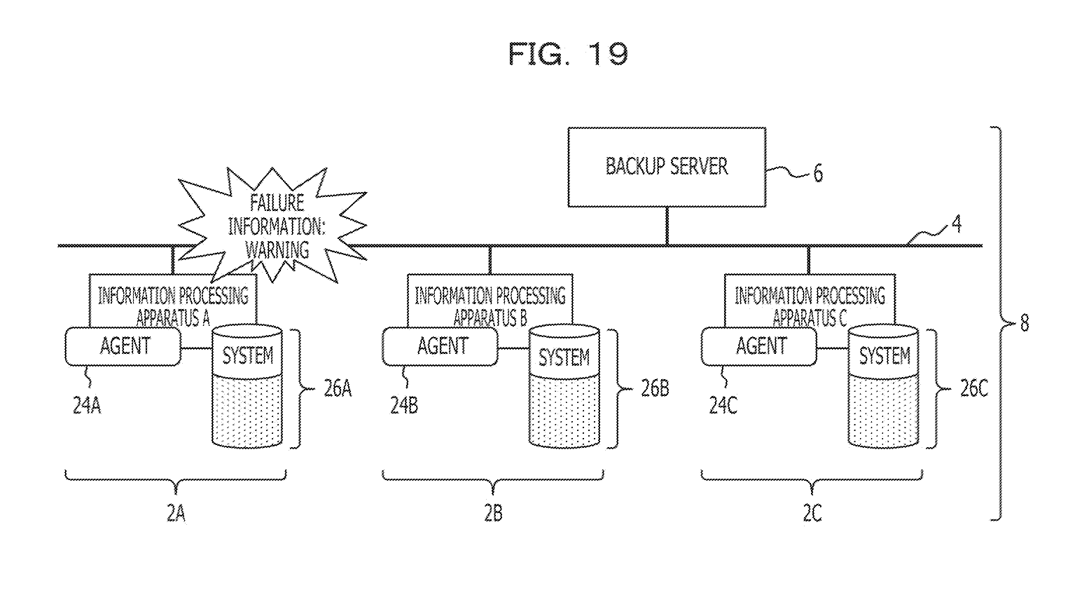

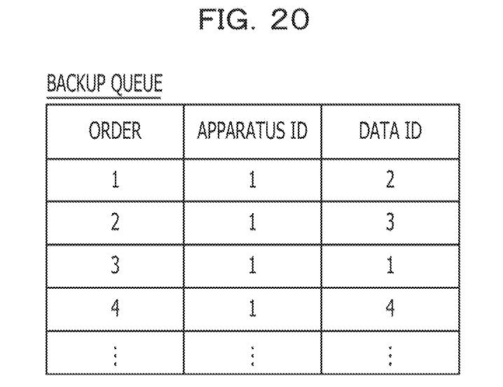

Next, with regard to an example of the backup processing by the information processing apparatus 2 and the backup server 6, a reference is made to FIG. 15, FIG. 16, FIG. 17, FIG. 18, FIG. 19, and FIG. 20. FIG. 15 and FIG. 16 illustrate exemplary apparatus information tables. FIG. 17 illustrates an example of a backup target information table which is notified to the backup server. FIG. 18 illustrates an exemplary backup queue. FIG. 19 illustrates a configuration example of a backup system in a case where a warning occurs in failure information of the information processing apparatus. FIG. 20 illustrates an exemplary backup queue. It should be noted that the configurations illustrated in FIG. 15 to FIG. 20 are examples and are not limited to these.

(1) Priority setting processing with respect to generation of an apparatus information table

A priority setting with respect to the apparatus information is executed by the backup server 6 that collects the apparatus information from the respective information processing apparatuses 2. The backup server 6 accordingly generates an apparatus information table 140 illustrated in FIG. 15. The apparatus information table 140 includes an apparatus name 142, an apparatus type 144, a use time 146, failure information 148, and an importance 150. Then, a priority 152 is set in the apparatus information table 140.

The backup server 6 first refers, for example, to the importance 150 in the priority setting processing and sets the priority=1 to an apparatus B having the apparatus ID=2 where the highest importance “high” is specified. Next, the backup server 6 sets the priority to the apparatus having the importance “medium”. In the case of the present embodiment, the importance “medium” is set for the apparatus ID=1, 3, 4, and 7, and in this case, the backup server 6 refers to the failure information 148. With regard to the failure information 148, the priority may be set in the descending order of a probability of failure, and the priority may be set in the order of the failure information 148 being “warning”, “attention”, and “none”. While following this, the backup server 6 sets the priority=2 for an apparatus C of the apparatus ID=3 that has “warning” and sets the priority=3 for an apparatus D of the apparatus ID=4 that has “attention”. In a case where the importance and the failure information are the same, a reference is made to the use time 146, and one with a longer use time may be prioritized. In the case of the present embodiment, with regard to the apparatus A of the apparatus ID=1 and an apparatus G of the apparatus ID=7, the importance and the failure information are the same. In view of the above, the backup server 6 sets the priority=4 for the apparatus G of the apparatus ID=7 and sets the priority=5 for the apparatus A of the apparatus ID=1.

Similarly, in an apparatus E of the apparatus ID=5 and an apparatus F of the apparatus ID=6, the importance 150 and the failure information 148 are the same, and one with a longer use time may be prioritized upon the setting on the priority. In view of the above, the backup server 6 sets the priority=6 for the apparatus F of the apparatus ID=6 and the priority=7 for the apparatus E of the apparatus ID=5. It should be noted that in a case where the use time is also the same in addition to the importance and the failure information, a reference is made to the apparatus type 144, and the priority may be decided, for example, in the order of the server and the PC.

(2) Backup processing in a case where “warning” does not exist in the failure information of the information processing apparatus

As an example of the backup processing, a setting processing for a transfer order in a case where the information processing apparatuses 2A, 2B, and 2C are connected to the backup server 6. As illustrated in FIG. 16, the backup server 6 creates the apparatus information table 140 in which the priority is set. In this setting on the priority, the backup server 6 refers to the importance 150 while following the criteria illustrated in (1) described above. In the case of the present embodiment, as all the severities are set as “medium”, the backup server 6 shifts to a determination of the failure information 148 without determining dominance in the importance.

With regard to the determination by the failure information 148, in the case of the present embodiment, the information processing apparatus 2B (apparatus B) is “attention” whereas the information processing apparatus 2A (apparatus A) and the information processing apparatus 2C (apparatus C) are “none”. With this configuration, the backup server 6 sets the highest priority=1 to the apparatus B. That is, this is because the backup processing is preferentially carried out on the information processing apparatus 2 in which the failure occurs or which has a high probability of the failure. With regard to the apparatus A and the apparatus C where the failure information 148 is the same, the backup server 6 refers to the use time 146 and assigns the higher priority to the apparatus with the longer use time. In the case of the present embodiment, as the use time of the apparatus C is longer than that of the apparatus A, the backup server 6 sets the priority=2 to the apparatus C. The backup server 6 sets the priority=3 to the remaining apparatus A.

FIG. 17 illustrates backup target information tables 154, 156, and 158 notified from the respective information processing apparatuses 2A to 2C. In the backup target information tables 154, 156, and 158, the priority is set with respect to the respective data IDs.

The backup server 6 generates a backup queue 160 illustrated in FIG. 18 by combining the apparatus information table 140 and the backup target information tables 154 to 158. In this creation of the backup queue 160, with regard to the monitoring target apparatus (information processing apparatus) where the importance 150 is the same and the failure information 148 is other than “warning”, the backup server 6 sets a backup target information table having a higher priority in a descending order in the backup queue 160. In the present embodiment, as the failure information 148 is not at the “warning” level, the backup server 6 sets the backup queue 160 so that the apparatus IDs=2, 3, and 1 are repeated in turn, for example, on the basis of the priority order of the apparatus information. That is, with regard to the orders 1 to 3 in the backup queue 160, the backup server 6 has the data in which the descending order of the apparatus priority is set for the apparatus order and the highest priority in the respective apparatuses is set for the data ID order.

(3) Backup processing in a case where “warning” exists in the failure information of the information processing apparatus

In the backup system 8 provided with the information processing apparatuses 2A to 2C and the backup server 6, for example, in a case where a failure occurs in the information processing apparatus 2A and “warning” is generated in the apparatus information, a reference is made to FIG. 19. The present embodiment illustrates, for example, a case in which the priority of the apparatus information on the information processing apparatuses 2A to 2C is the same.

As described above, in a case where “warning” exists in the apparatus information, the priority of the apparatus information corresponding to such an apparatus is set to be high, and the backup processing is prioritized. In view of the above, in a backup queue 162 generated in the present embodiment, as illustrated in FIG. 20, to process the information processing apparatus 2A having the apparatus ID=1 in priority, the orders 1 to 4 are set for the data of the information processing apparatus 2A. It should be noted that although the backup target information table in this case is not illustrated in the drawing, the priority may be set while following the above-mentioned setting criteria, and in the backup queue 162, for example, the priority is set in the order of the data IDs=2, 3, 1, and 4.

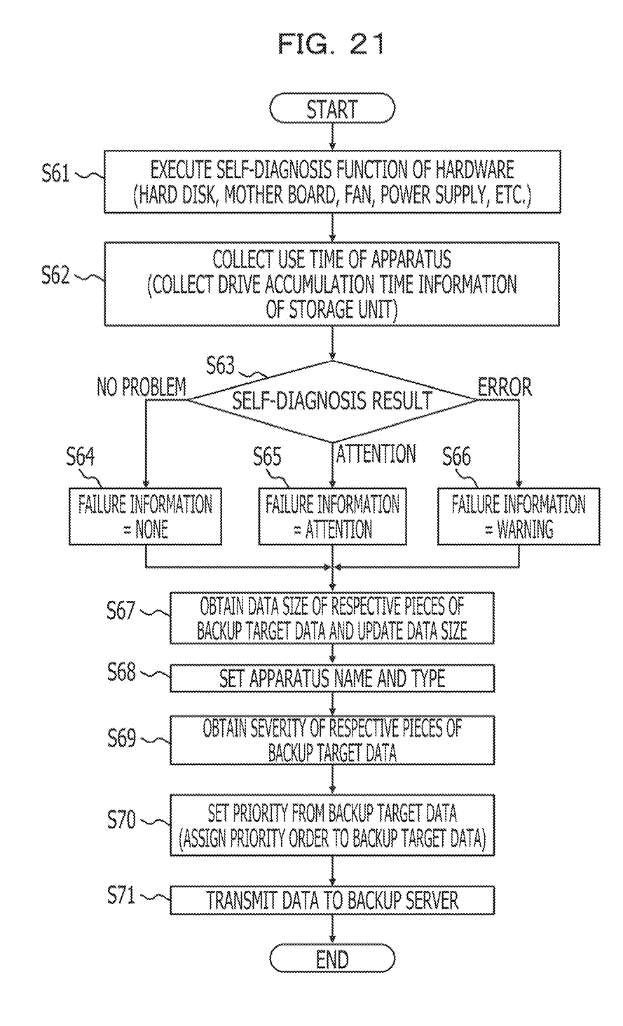

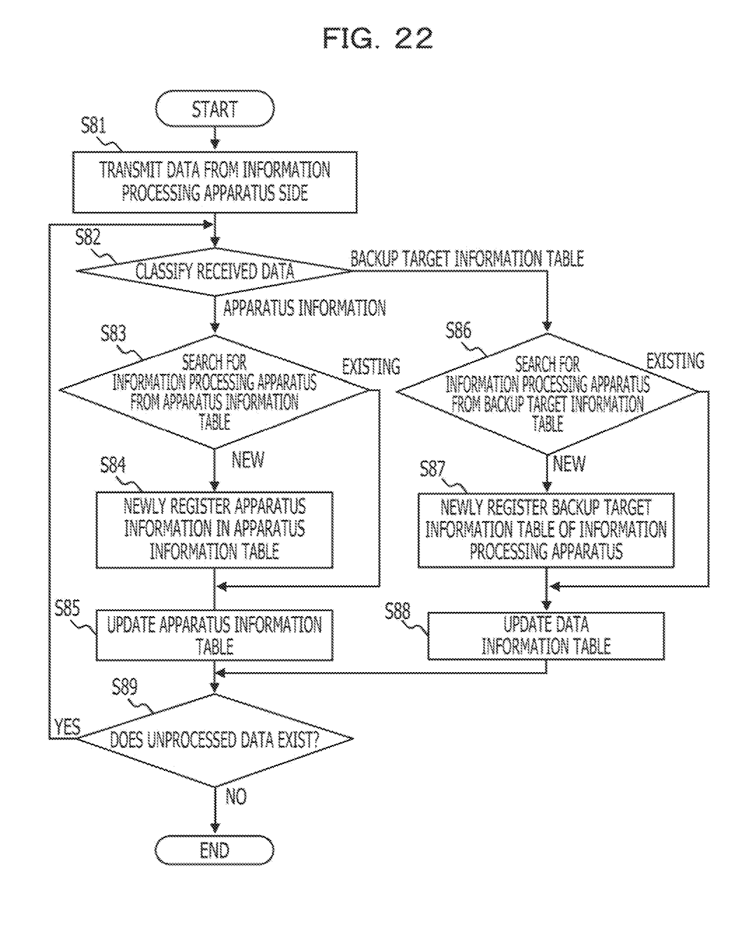

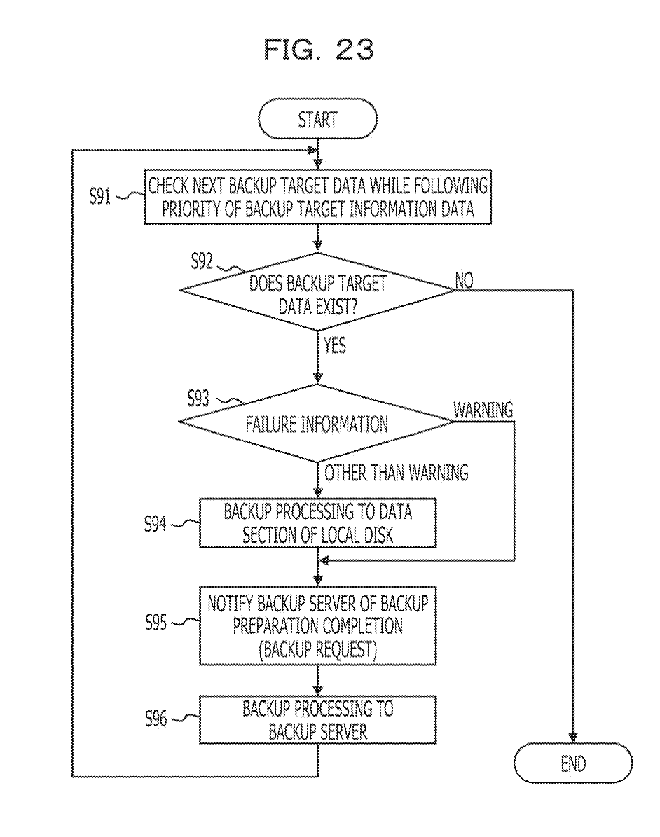

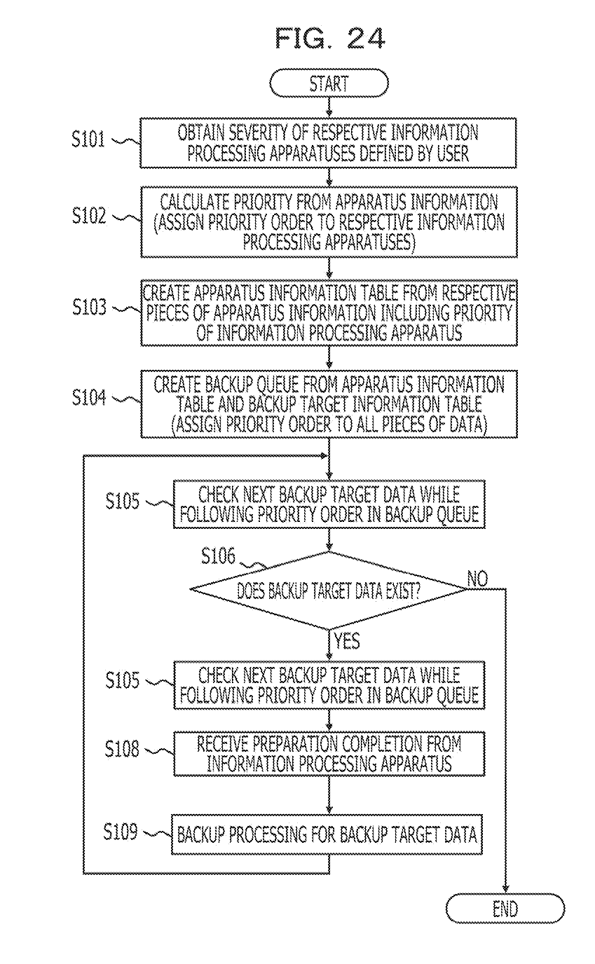

Next, with regard to an example of a processing procedure for executing the above-mentioned backup processing by the information processing apparatus 2 and the backup server 6, a reference is made to FIG. 21, FIG. 22, FIG. 23, and FIG. 24. FIG. 21 is a flow chart illustrating obtainment of monitoring information and an example of a data transfer preparation processing in the information processing apparatus. FIG. 22 is a flow chart illustrating an example of a data transfer preparation processing in the backup server. FIG. 23 is a flow chart illustrating an example of a data backup processing in the information processing apparatus. FIG. 24 is a flow chart illustrating an example of a backup data transfer processing in the backup server. It should be noted that the processing contents, the processing procedures, and the like illustrated in FIG. 21 to FIG. 24 and are not limited to these.

The transfer preparation processing and the backup data transfer processing by the information processing apparatus 2 and the backup server 6 are examples of a backup program and a backup method according to the present disclosure. In this processing, the apparatus information of the respective information processing apparatuses 2, the monitoring information of the backup data, and the like are collected, and the backup server 6 is notified thereof. The backup server 6 generates transfer order information on the basis of the transferred monitoring information and performs a transfer control on the backup data with respect to the information processing apparatus 2 on the basis of the transfer order.

In the processings for the obtainment of the monitoring information of the information processing apparatus 2 and the data transfer preparation, as illustrated in FIG. 21, the self-diagnosis function of the hardware is executed (Operation S61). The self-diagnosis function is controlled by the agent program 24. The self-diagnosis function collects, for example, the apparatus information of the disk drive, a mother board, a fan, a power supply apparatus, or the like that is an example of the storage device 102. And, in the present processing, collection of the use time of the apparatus is carried out (Operation S62). Through this collection, drive accumulation time information of the storage device 102 is collected.

In the present processing, the self-diagnosis result is determined (Operation S63). In the present processing, in a case where the failure information or the like is not obtained on the basis of the self-diagnosis, it is determined that no problem occurs (Operation S63; no problem), and “none” is set in the failure information (Operation S64). And, in the present processing, in a case where it is determined that an error may occur on the basis of the diagnosis result (Operation S63; attention), “attention” is set in the failure information (Operation S65). This diagnosis result indicating “attention” is output, for example, to the respective components of the information processing apparatus 2 in a case where the use time is longer than or equal to a certain time period or the like. And, in a case where the diagnosis result indicates “error” (Operation S63; error), in the present processing, “warning” is set in the failure information (Operation S66).

In the present processing, after the processing related to the self-diagnosis, the procedure is shifted to the information collection processing for creating the backup target information table of the information processing apparatus 2. In the present processing, the data size information of the respective pieces of the backup target data and the size information of the update data (Operation S67). And, in the present processing, the apparatus name and type of the apparatus that holds the backup data are set (Operation S68), and the importance of the respective pieces of the backup target data is obtained (Operation S69). For this importance, for example, the information set by the user or the information previously set in the respective pieces of data may be utilized.

In the present processing, while the obtained importance, the data size information, the use time information of the apparatus, and the like, are taken into account, the priority is set on the basis of the backup target information (Operation S70). Then, the data such as the monitoring information including the backup target information table, the apparatus information, and the like which is created on the basis of the collected information is transmitted to the backup server 6 side (Operation S71), and the present processing is ended.

As illustrated in FIG. 22, in the data transfer preparation processing in the backup server, when the data such as the monitoring information is received from the information processing apparatus 2 (Operation S81), this data is classified (Operation S82).

In a case where the received data is the apparatus information (Operation S82; the apparatus information), in the present processing, a reference is made to the apparatus information table held by the backup server 6 to search whether or not the received apparatus information exists in the apparatus information table (Operation S83). In a case where the received apparatus information does not exist in the apparatus information table (Operation S83; new), this apparatus information is newly registered in the apparatus information table (Operation S84), and the apparatus information table is updated (Operation S85). On the other hand, in a case where the received apparatus information is already recorded in the apparatus information table (Operation S83; existing), in the present processing, the relevant information in the apparatus information table is updated with the received apparatus information (Operation S85).

In a case where the received data is the backup target information table (Operation S82; the backup target information table), in the present processing, a reference is made to the backup target information table held by the backup server 6 to search for the information processing apparatus corresponding to the received backup target information table (Operation S86). In a case where the information of the information processing apparatus does not exist in the backup target information table (Operation 86; new), in the present processing, the received backup target information table is newly registered (Operation S87), and the data information table is updated (Operation S88). And, in a case where the information processing apparatus indicated in this backup target information table is existing (Operation S86; existing), the data information table is updated with the received backup target information table (Operation S88).

In the present processing, it is determined whether or not unprocessed data exists among the received data (Operation S89). In a case where the unprocessed data exists (Operation S89; YES), in the present processing, the procedure is returned to the data classification processing (Operation S82). On the other hand, in a case where the unprocessed data does not exist (Operation S82; NO), and the present processing is ended.

As illustrated in FIG. 23, the backup processing in the information processing apparatus checks whether the presence or absence of the next backup target data while following the priority of the backup target information data (Operation S91). In a case where the backup target data exists (Operation S92; YES), in the present processing, the failure information is checked (Operation S93). In a case where the failure information of the apparatus that holds the backup target information is other than “warning” (Operation S93; other than warning), in the present processing, the data that becomes the backup target is backed up in the data section 32 (the data storage devices 26) of the local disk (Operation S94). After that, in the present processing, a backup preparation completion notification is transmitted to the backup server 6 as a backup request (Operation S95). And, in a case where the failure information is “warning” (Operation S93; warning), in the present processing, the backup to the local disk is not carried out, and immediately the backup request to the backup server 6 is carried out (Operation S95).

After that, when the transfer instruction from the backup server 6 is received, in the present processing, the backup processing of transferring the backup data to the backup server 6 is carried out (Operation S96). This backup processing is continued until the transfer processing of the backup target data recorded in the backup target information table is ended.

As illustrated in FIG. 24, in the backup data transfer processing on the backup server 6 side, for example, the importance of the respective information processing apparatuses defined by the user is obtained (Operation S101). In the present processing, by utilizing the obtained apparatus information from the respective information processing apparatuses 2, the priority based on the apparatus information is calculated, and the priority of the respective information processing apparatuses 2 is set (Operation S102). Then, in the present processing, the apparatus information table including the priority and the apparatus information is created (Operation S103). After that, in the present processing, by utilizing this apparatus information table and the backup target information table, the backup queue in which the transfer order information is regulated is created (Operation S104).

As a transfer processing stage for the backup data, in the present processing, the presence or absence of the next backup target data is checked while following the priority order in the backup queue (Operation S105). In a case where the backup target data exists (Operation S106; YES), in the present processing, the reception of the backup preparation completion notification related to the backup target data stands by (Operation S107). Then, when the backup preparation completion is received from the information processing apparatus 2 side (Operation S108), in the present processing, the backup processing for the backup target data is performed (Operation S109). In this backup processing, in the present processing, the transfer instruction is output to the information processing apparatus 2 side, and in accordance with this transfer instruction, the backup data transmitted from the information processing apparatus 2 is received, and then the backup data is stored in the data section 32 of the data storage devices 26 which is the backup storage unit. This backup processing is carried out with respect to all pieces of the backup target data enumerated the backup queue.

According to the above-mentioned embodiment, the backup is executed while taking into account the priority of the data that should be backed up. According to this configuration, the effective data is backed up in priority, and even when the backup is not completed with respect to all pieces of the data, a probability in which the effective data can be restored is increased. As a result, the usability of the effective data can be enhanced. And, the priority of the backup is decided in accordance with the state of the information processing apparatus. According to this configuration, the backup of the apparatus with the failure is executed in priority. And, the data transfer amount in the backup is reduced, and it is possible to execute the maintenance operation without imposing a limitation on the time.

[Fifth Embodiment]

A fifth embodiment relates to a restore processing in which a system recovery and a data reintegration of the information processing apparatus are carried out while utilizing the backup data.

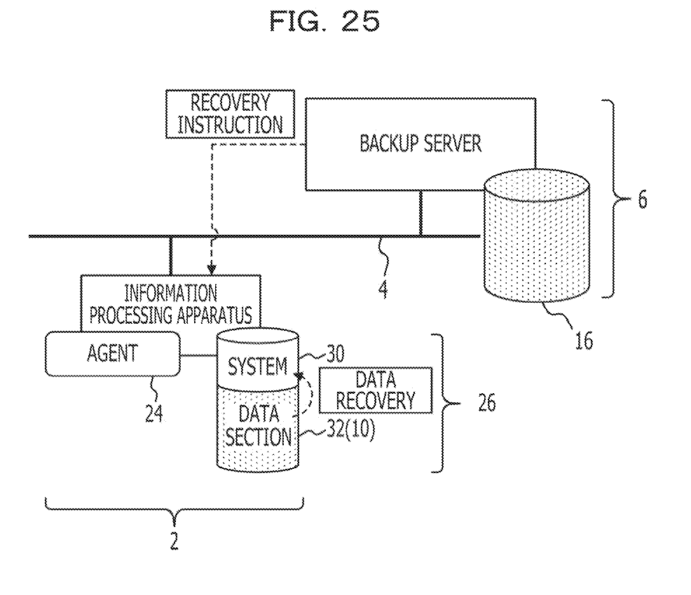

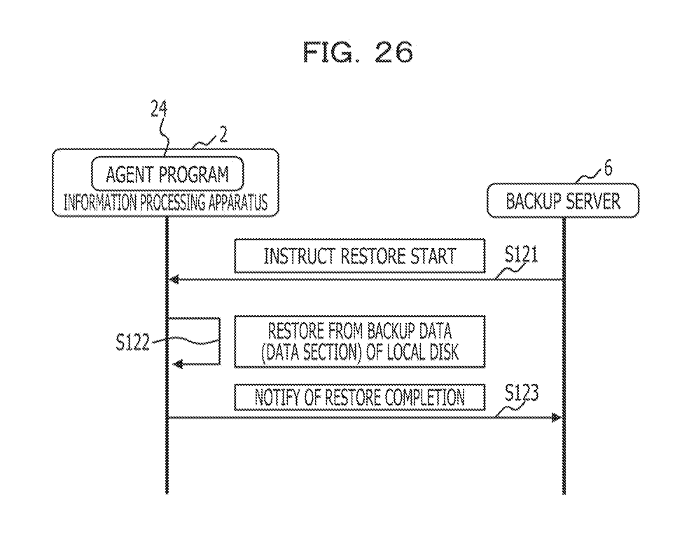

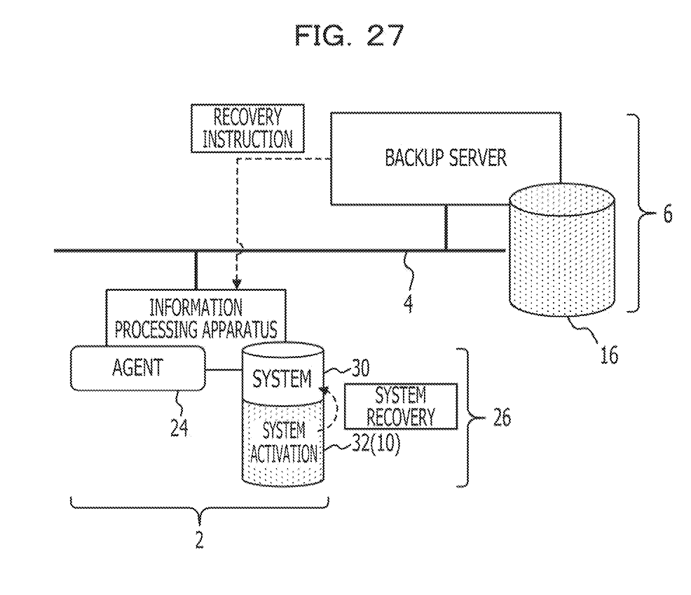

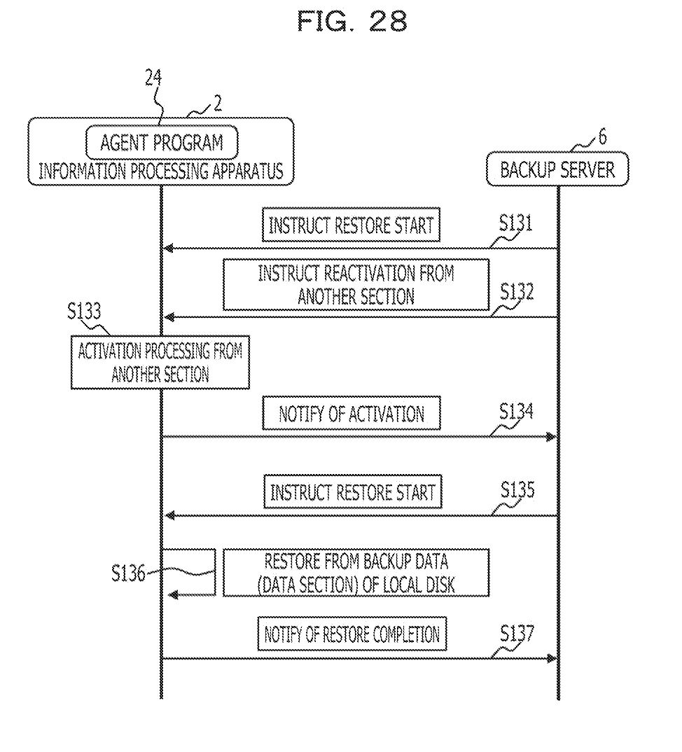

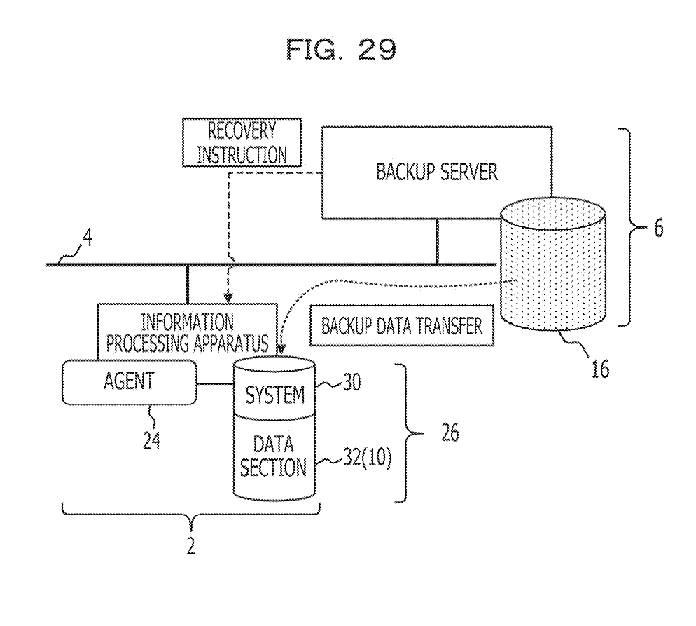

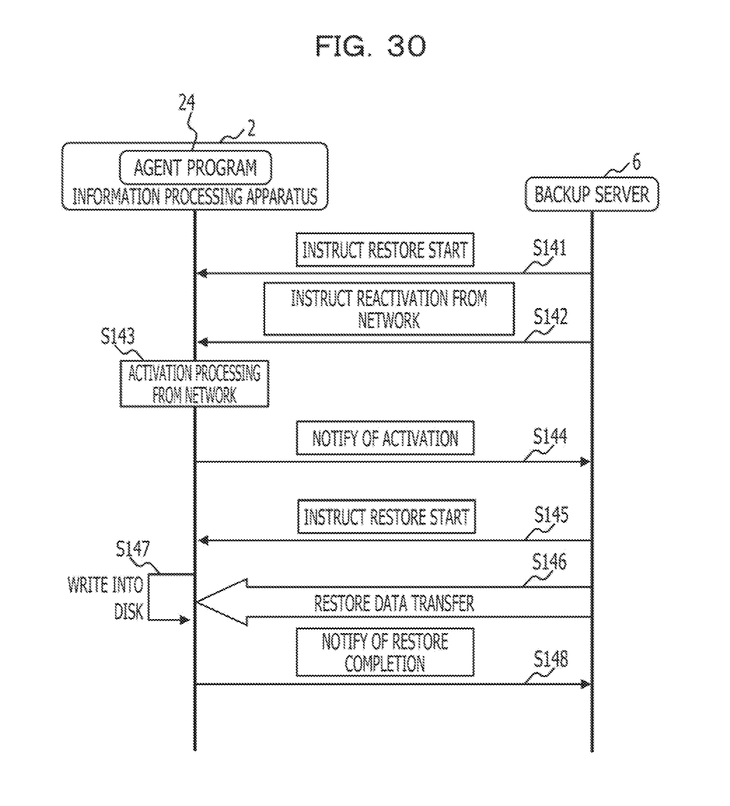

With regard to the fifth embodiment, a reference is made to FIG. 25, FIG. 26, FIG. 27, FIG. 28, FIG. 29, and FIG. 30. FIG. 25 illustrates a configuration example for executing a restore of data from backup data stored in the information processing apparatus. FIG. 26 is a sequence diagram illustrating a restore processing example of the data using the backup data stored in the information processing apparatus. FIG. 27 illustrates a configuration example for a restore processing of a system based on backup data in a data segment of the information processing apparatus. FIG. 28 illustrates a sequence example of the restore processing of the system based on the backup data in the data segment of the information processing apparatus. FIG. 29 illustrates a configuration example for a restore processing of a system based on backup data stored in the backup server. FIG. 30 illustrates a sequence example of the restore processing of the system based on the backup data stored in the backup server. It should be noted that the configurations, the processing contents, the processing procedures, and the like illustrated in FIG. 25 to FIG. 30 and are not limited to these.

The restore processing with respect to this information processing apparatus 2 is an example of the information processing apparatus, the backup server, the backup program, the backup method, and the backup system according to the present disclosure. A trigger for the start of this restore processing is, for example, a time when the information processing apparatus 2 used by the user is not activated, a time when the data is broken, a time when an access cannot be made from another information processing apparatus connected to the network, a time when “warning” is set in the apparatus information, or the like.

The restore processing is started in response to the recovery instruction output from the backup server 6. In this restore processing, for example, the backup data is read out from the backup data storage unit 10 of the information processing apparatus 2, and the data or system of the information processing apparatus 2 is recovered. In this restore processing, the backup data is received from the backup server 6, and the function of the information processing apparatus 2 may be recovered with this backup data in some cases.

(1) Restore processing based on the backup data stored in the information processing apparatus (FIG. 25)

In this restore processing, for example, the backup data is read out from the data section 32 in the locally-connected data storage device 26 connected to the information processing apparatus 2 to the system section 30 to carry out the data recovery. In view of the above, when the agent program 24 of the information processing apparatus 2 can be activated while following the recovery instruction from the backup server 6, in a case where the recovery of the system section is unnecessary, after the activation of the information processing apparatus 2, the data recovery is carried out while utilizing the data section 32. In this case, as the backup data is not transferred from the backup server 6 to the information processing apparatus 2, the network channel is not applied with load.

As illustrated in FIG. 26, in this restore processing, for example, when the restore start instruction from the backup server 6 is received on the information processing apparatus 2 side (Operation S121), the backup data stored in the data section 32 in the local disk of the information processing apparatus 2 is read out to carry out the restore (Operation S122). Then, when the read out of the backup data is ended, the restore completion notification is transmitted from the information processing apparatus 2 to the backup server 6 (Operation S123), and the restore processing is completed.

(2) Restore processing of the system based on the backup data in the data section of the information processing apparatus (FIG. 27)

In this restore processing, for example, when it is determined that the agent program 24 operating in the information processing apparatus 2 suffers a system fault, system data for activation which is stored in the system section 30 is recovered. In this case, while following the recovery instruction from the backup server 6, the activation of the information processing apparatus 2 utilizing another section other than the system section 30 in the data storage devices 26 is carried out. For example, the information processing apparatus 2 is activated by using a recovery section, the system data is read out from the backup data stored in the data section 32, and it is possible to recover the system section 30 by using the system data. In this restore processing too, as the backup data is not transferred from the backup server 6 to the information processing apparatus 2, the network channel is not applied with load.

As illustrated in FIG. 28, in this restore processing, the restore start instruction is transmitted from the backup server 6 to the information processing apparatus 2 (Operation S131). Furthermore, a reactivation instruction from another section is transmitted from the backup server 6 to the information processing apparatus 2 (Operation S132). For example, in a case where this restore start instruction is not received on the information processing apparatus 2 side, similarly, the reactivation instruction may be transmitted.

In accordance with this reactivation instruction, the information processing apparatus 2 performs the reactivation by utilizing another section other than the system section 30 (Operation S133) and transmits an activation notification to the backup server 6 (Operation S134). To restore the data of the system section 30, the backup server 6 receiving the activation notification from the information processing apparatus 2 transmits the restore start instruction to the information processing apparatus 2 (Operation S135).

In response to the restore start instruction, the information processing apparatus 2 reads out the system data from the backup data stored in the data section 32 of the local disk to execute the restore processing (Operation S136). Then, when the read out of the backup data is ended, the restore completion notification is transmitted from the information processing apparatus 2 to the backup server 6 (Operation S137), and the restore processing is completed.

(3) Restore processing of the system based on the backup data stored in the backup server (FIG. 29).

This restore processing is executed in a case where the information processing apparatus 2 cannot access the data storage devices 26 and the information processing apparatus 2 cannot be activated because of, for example, occurrence of a disk fault or the like. In this case, the backup server 6 determines that this is a state in which the information processing apparatus 2 cannot perform the self-recovery, for example, if a response from the information processing apparatus 2 does not exist, and the backup server 6 performs the activation processing for the information processing apparatus 2 via the network. For example, the backup server 6 activates the information processing apparatus 2 via the network 4 with a network boot function and performs a recovery processing on the system while transferring the backup program to the information processing apparatus 2. In this case, the backup data in the backup server 6 is transferred to another storage means of the information processing apparatus 2, and by utilizing the data, the recovery processing against the disk fault is carried out.

As illustrated in FIG. 30, the restore start instruction is transmitted from the backup server 6 to the information processing apparatus 2 (Operation S141). In a case where the information processing apparatus 2 is not activated while following this restore start instruction, the backup server 6 determines that this is a state in which the information processing apparatus 2 cannot perform the self-recovery and performs the reactivation instruction from the network 4 (Operation S142). When the information processing apparatus 2 is activated by the network boot in accordance with this activation instruction (Operation S143), the activation notification is transmitted to the backup server 6 (Operation S144). When this activation notification is received, the backup server 6 transmits the restore start instruction to the information processing apparatus 2 (Operation S145) and transfers the backup data from the backup data storage unit 16 as the restore data (Operation S146). In the transfer of this backup data, for example, by utilizing the above-mentioned apparatus information and the backup target information table, necessary data is identified. As the transfer processing of the backup data is carried out while following the transfer order decided on the basis of this backup target information table and the priority of the backup queue, the load applied on the network channel is reduced.

The information processing apparatus 2 writes the transferred restore data in the data storage device 26 of the information processing apparatus 2 (Operation S147) and notifies the backup server 6 of the restore completion (Operation S148). According to this configuration, the restore processing is ended.

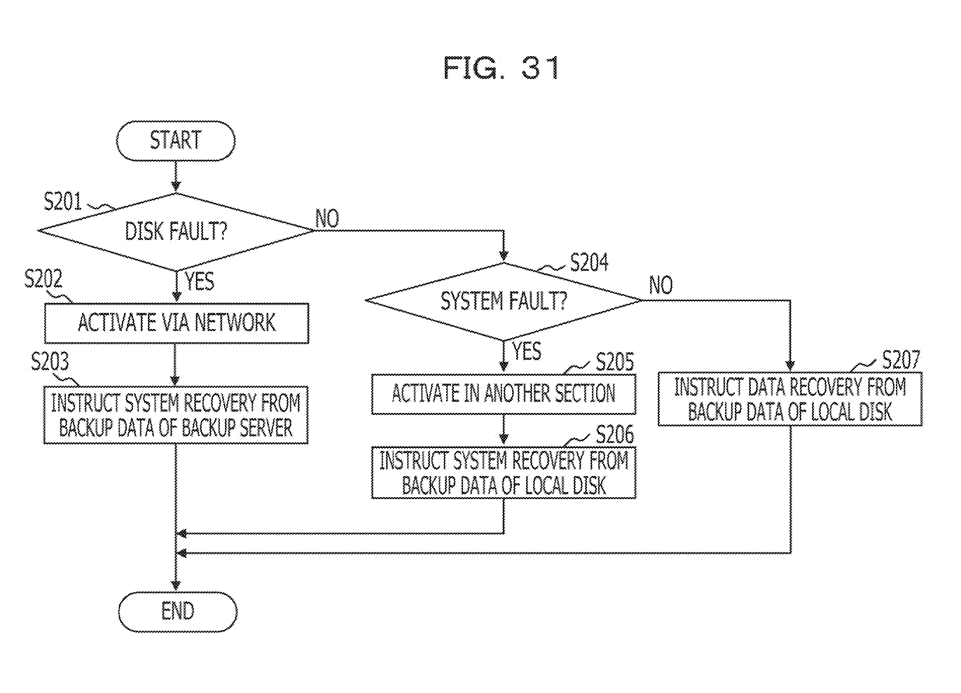

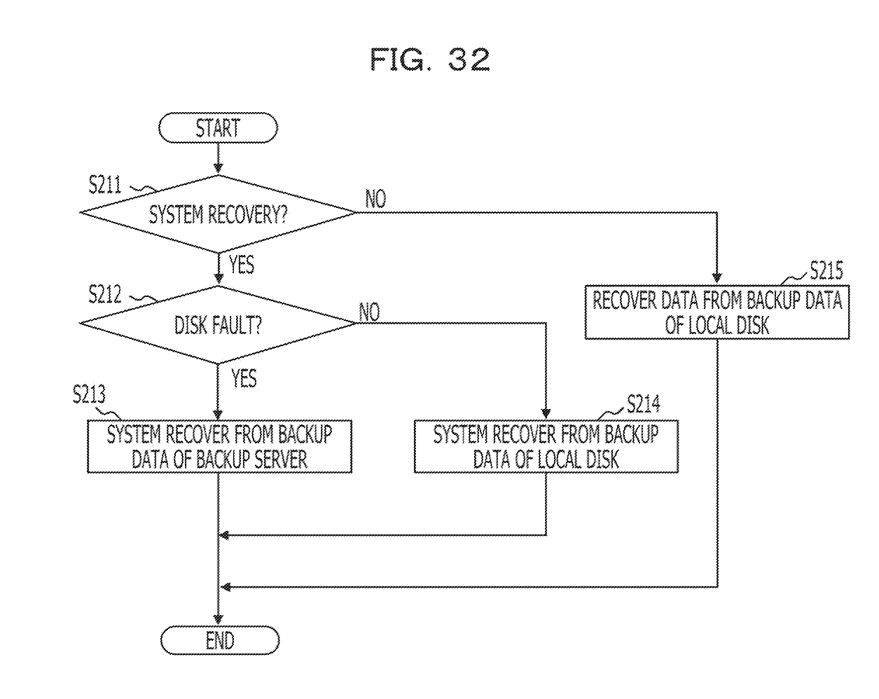

Next, with regard to a processing procedure for executing the restore processing by the backup server and the information processing apparatus, a reference is made to FIG. 31 and FIG. 32. FIG. 31 is a flow chart illustrating an example of the restore processing in the backup server. FIG. 32 is a flow chart illustrating an example of the restore processing in the information processing apparatus. It should be noted that the processing contents, the processing procedures, and the like illustrated in FIG. 31 and FIG. 32 and are not limited to these.

This restore processing is an example of the backup method and the backup program according to the present disclosure, where which one of the backup data of the local disk and the backup data obtained from the backup server 6 via the network is used for performing the processing is decided in accordance with the state of the information processing apparatus 2.

As illustrated in FIG. 31, the backup server 6 determines whether or not the disk fault occurs in the information processing apparatus 2 (Operation S201). In a case where the disk fault occurs (Operation S201; YES), the backup server 6 issues an activation instruction to the information processing apparatus 2 via the network (Operation S202). That is, as described above, in a case where the data storage device 26 of the information processing apparatus 2 does not function, the backup server 6 activates the information processing apparatus 2 with the network boot to be connected to the network 4. Then, as the transfer processing for the restore data, the backup server 6 transfers the backup data kept in the backup server 6 to the information processing apparatus 2 and outputs an instruction for performing the system recovery with this data (Operation S203).

In a case where the disk fault does not occur in the information processing apparatus 2 (Operation S201; NO) and the system fault in the information processing apparatus 2 occurs (Operation S204; YES), the backup server 6 activates the information processing apparatus 2 from another section such as the recovery section (Operation S205). When the information processing apparatus 2 is activated, the backup server 6 outputs an instruction to the information processing apparatus 2 so as to read out the system data from the backup data stored in the data section 32 in the data storage devices 26 which is the local disk and transfer the system data to the system section 30 for recovering the system (Operation S206).

In a case where the system fault does not occur in the information processing apparatus 2 (Operation S204; NO), with respect to the information processing apparatus 2, the backup server 6 transfers the necessary backup data from the data section 32 of the local disk to the system section 30 for recovering the data (Operation S207).

In the restore processing in the information processing apparatus 2, as illustrated in FIG. 32, first, it is determined whether or not it is necessary to recover the system (Operation S211). In a case where it is necessary to recover the system (Operation S211; YES), the information processing apparatus 2 determines whether or not the disk fault occurs such as the breakage of the data storage devices 26 (Operation S212). In a case where the disk fault occurs (Operation S212; YES), the information processing apparatus 2 recovers the system by utilizing the backup data kept in the backup server 6 (Operation S213).

In a case where it is necessary to recover the system (Operation S211; YES) and the disk fault does not occur (Operation S212; NO), the information processing apparatus 2 recovers the system by utilizing the backup data kept in the data section 32 of the local disk (Operation S214).

In a case where it is not necessary to recover the system (Operation S211; NO), after the system is activated, the information processing apparatus 2 reads out the necessary data from the data section 32 of the local disk to the system section 30 for the recovery (Operation S215).

According to the above-mentioned embodiment, while the backup utilizing the network and the local backup are used in combination, by using the local backup data in a case where it is not necessary to recover the system, the data is recovered without applying the load on the network channel. And, the transfer order is set on the basis of the priority or the like of the backup data, and the backup of the data having the high importance is prioritized, so that the reliability of the restore function when the system fault or the like occurs can be increased. And, as the transfer order for the backup data is decided on the basis of the backup target information table and the priority of the backup queue and the transfer processing is executed, the load applied on the network channel is reduced. And, as the backup data is saved in the network, even in a case where the information processing apparatus cannot perform the recovery from the local disk because of the breakage of the disk or the like, it is possible to perform the recovery via the network. The data transfer amount at the time of backup/restore is reduced, and it is possible to execute the maintenance operation without imposing a limitation on the time.

[Comparison Example]

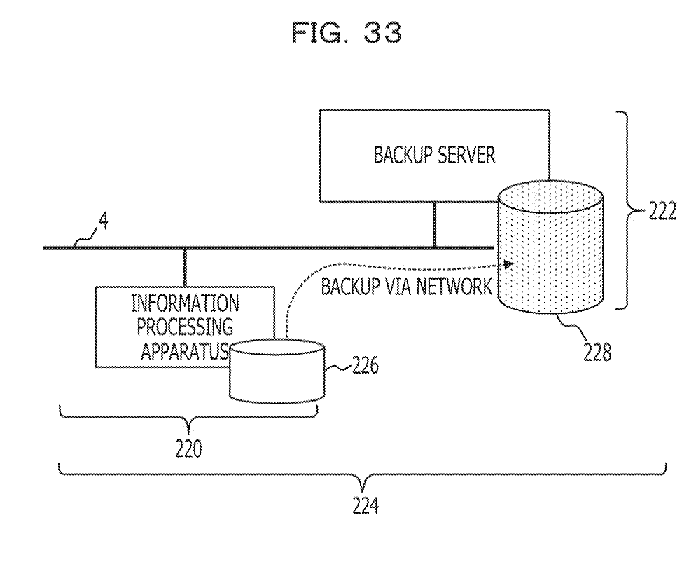

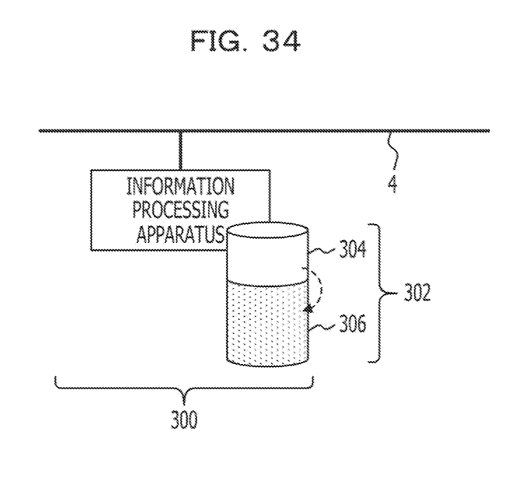

Next, regarding a comparison example with respect to the above-mentioned embodiments, a reference is made to FIG. 33 and FIG. 34. FIG. 33 illustrates a network type backup system in a comparison example. FIG. 34 illustrates a stand alone type backup system in a comparison example.

This comparison example is a network type backup system in related art, which is, as illustrated in FIG. 33, a backup system 224 constructed by an information processing apparatus 220 and a backup server 222 on the network 4. In the backup system 224, backup data is generated in a storage device 226 provided to the information processing apparatus 220, and this backup data is transferred to the backup server 222 side via the network 4. The backup server 222 stores and keeps the backup data transferred from the information processing apparatus 220 in a backup data storage unit 228. At the time of the restore of the information processing apparatus 220, this backup data is transferred from the backup server 222 via the network 4 to the information processing apparatus 220.

In the network type backup system illustrated in this comparison example, the information processing apparatus 220 performs the backup control. For that reason, if the plurality of information processing apparatuses 220 execute the backup processing by using the backup server 222 around the same time, the network channel is applied with significant load even when the data transfer amount for each information processing apparatus is limited to a certain amount, for example. Additionally, if the execution of the backup processing is continued for a long period of time because of such decrease in data transfer speed which is caused by the load on the network channel, a normal operation of the information processing apparatus 220 is affected. Furthermore, because of the simultaneous data transfer from a large number of information processing apparatuses, the processing performance of the backup server 222 is also decreased.

A stand alone type backup system in related art illustrated in FIG. 34 saves the backup data of the system section 304 in a local disk 302 connected to an information processing apparatus 300 in a data section 306 in the local disk 302. In this case, if the breakage of the local disk 302 or the like is caused, the backup data may be lost.

The problems illustrated in the above-mentioned comparison example are solved by the backup function illustrated in the above-mentioned embodiments.

[List of Characteristic Items of the Above-Mentioned Embodiments and Other Embodiments]

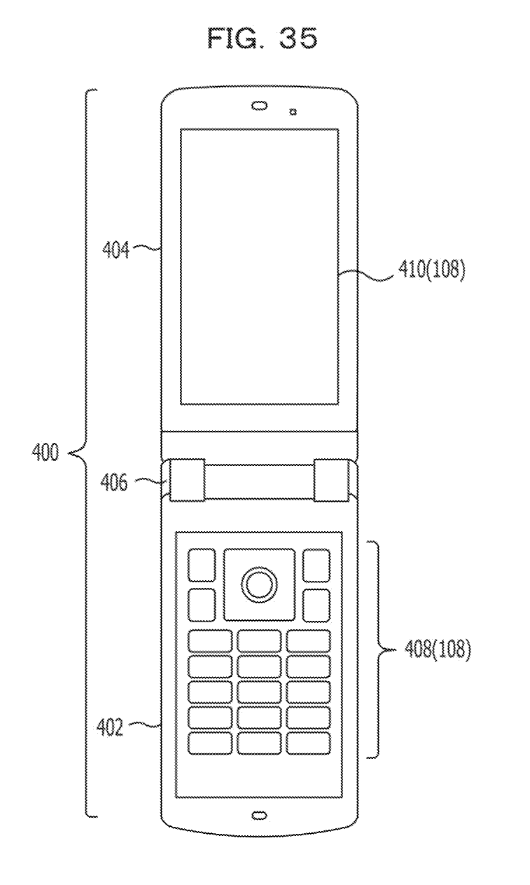

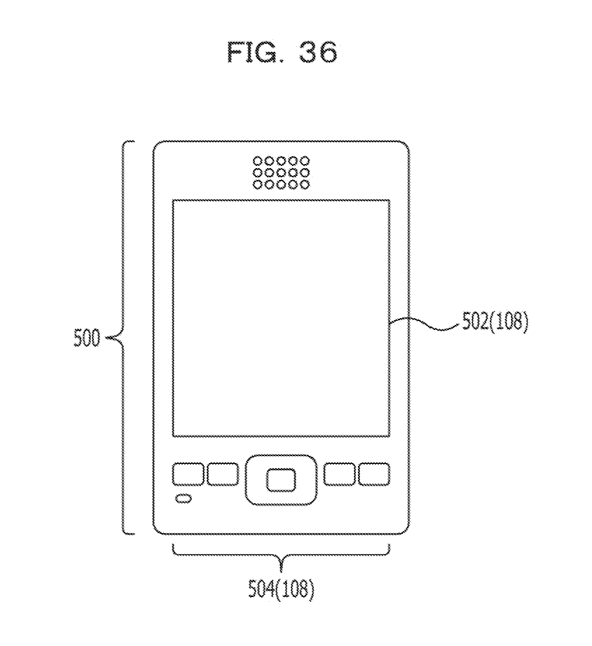

(1) The above-mentioned embodiments illustrate the PC 200 (FIG. 13) as an example of the information processing apparatus, but the configuration is not limited to this. For example, the apparatus to which the above-mentioned embodiments are applied may be, as illustrated in FIG. 35 and FIG. 36, a mobile phone device 400 provided with a communication function to the network, a mobile information terminal device (PDA: Personal Digital Assistant) 500, or the like.

As illustrated in FIG. 35, the mobile phone device 400 is, for example, an apparatus in which an operation side casing section 402 and a display side casing section 404 are coupled so as to be opened and closed by a hinge section 406. The operation side casing section 402 is provided with an operation input unit 408. The display side casing section 404 is provided with a display unit 410 and the like. For example, the backup system for the mobile phone device 400 may save data stored in a memory in the mobile phone device 400 in an external server apparatus, a PC, or the like as backup data via a network and save the data in a part of a memory that is set as a backup section. The backup section may be an external memory detachably attached to the mobile phone device 400 such as an SD card instead of a memory in the mobile phone device 400.

As illustrated in FIG. 36, a PDA 500 is provided with a display unit 502, an operation unit 504, and the like. The PDA 500 is provided with a memory therein and may save data stored in a memory in an external server apparatus, a PC, or the like via a network as backup data and save the data in a part of a memory that is set as a backup section. With the above-mentioned configuration too, the above-mentioned problems are solved.

(2) The above-mentioned embodiments illustrates the setting criteria for the priority of the backup target information table 62, but the setting criteria are not limited to these. For example, in the respective information processing apparatuses 2, in a case where the user sets the same importance 72 (FIG. 9), the higher priority may be set as the data size 68 is larger. And, on the basis of frequency information on the data updates or the like, the level of the priority may be set in accordance with the scale of the frequency. With the above-mentioned configuration too, the above-mentioned object is achieved.

(3) The setting criteria for the priority of the apparatus information table 46 (FIG. 7) or 140 (FIG. 15, FIG. 16) are not limited to the criteria illustrated in the above-mentioned embodiments.

For example, in a case where the user sets the same importance 72 (FIG. 9), the type information and the use time are first determined, and then the priority may be set.

(4) According to the above-mentioned embodiments, only the transfer order based on the backup queue 78 (FIG. 10) that is the transfer order information is controlled by the backup server 6, but the configuration is not limited to this. For example, the backup server 6 may perform a transfer amount control together with this transfer order control. In this case, the backup server 6 may limit the transfer amount, for example, in accordance with the use situation of the network 4, the load situation caused in the backup server 6, or the size of the backup data to be transferred. According to the above-mentioned configuration, for example, even in day time or the like at a time when the use frequency of the network channel or the information processing apparatus 2 is high, the load caused by the backup processing is further reduced.

(5) In the above-mentioned embodiments, the backup queue added with a time condition when the backup processing is carried out may be set. For example, the backup queue may be set in such a manner that in a case where the size of the backup data to be transferred is larger than a predetermined size, the backup server 6 is caused to execute the backup processing on the data in a time slot when the use frequency of the network 4 is low. In this case, for example, the time condition may be set so that the data requiring a prompt backup is backed up in priority.

(6) According to the above-mentioned embodiments, the backup data is saved in the backup data storage unit 16 that is built in or externally connected to the backup server 6, but the configuration is not limited to this. For example, the backup data may be stored in another storage means connected to the network other than the backup server 6. In this case, for example, the backup server 6 may perform the control on the transfer order, and the other storage means may perform the data storage. And, the backup system 8 may be provided with a plurality of backup servers 6. In this case, for example, a coordination control such as a control on a transfer destination of the backup data may be carried out between the backup servers 6 in accordance with a timing for the backup processing and the load.

(7) According to the above-mentioned embodiments, the local backup is carried out in conformity to the timing of the network backup, but the configuration is not limited to this. For example, the local backup may be carried out independently during a standby of the transfer timing for the network backup.

(8) By performing the data transfer at a low speed in the background of the network processing, the connected network does not have a restriction on the form thereof: for example, the backup server and the information processing apparatus are installed in the same segment or various protocols are passed with a router. For that reason, the backup system according to the present disclosure may be applied to various wide area networks and the like.

(9) By performing the control while using the network type backup system and the stand along type backup system in combination, the backup system having the advantages of both the systems is provided.

(10) In the backup processing according to the present disclosure, the activation section is created in addition to the section that becomes the backup target in the disk. In a case where the backup is extracted from the system section, the backup data is stored in the activation section other than the system section or the data section 32 other than the above.

(11) In the backup processing to the local disk, in accordance with the instruction from the backup server 6 or automatically, the backup data is stored in the local disk. In the present backup processing, in this stage, as the backup data is not transferred to the backup server 6, the large amount of data does not flow onto the network.

(12) In the transfer of the backup data to the backup server 6, in the backup server 6, for each of the backup target apparatuses, the apparatus information in which the priority is set is registered. Then, while the system is running, the backup data of the data section 32 is stored in the backup server via the network 4. At this time, for example, so as not to apply the load on the network, the transmission amount of the backup data may be adjusted.

(13) In the restore processing, in a case where it becomes necessary to restore the data, the agent program 24 performs the communication and obtains the necessary data from the local disk to be restored. And, in a case where it is necessary to perform the recovery because of the system fault, in response to the instruction from its own apparatus, the backup server 6 activates the information processing apparatus by using the activation section other than the system section to read out the system data from the backup data in the local disk to recover the system section 30. In this manner, as the backup data is not transferred from the backup server 6 to the information processing apparatus, the network is not applied with the load.

(14) In a case where the communication utilizing the agent program 24 on the information processing apparatus 2 side cannot be carried out, the backup server 6 determines that the system of the information processing apparatus 2 cannot be activated. Then, the backup server 6 boots the information processing apparatus 2 via the network and recovers the system by using the backup data stored in the local disk of the information processing apparatus 2.

(15) According to the present embodiment, the backup system is constructed where the backup is executed on the basis of the priority decided by the apparatus information and the backup target information. And, according to the present embodiment, in accordance with the situation of the information processing apparatus 2, the system is constructed where one of via the network and the data section 32 of the local disk (the backup data) is selected as the restore origin. This information processing apparatus 2 is provided, for example, with the agent program 24 for checking whether or not the system can be activated and deciding the priority of the backup target of its own apparatus by the backup target information. The information processing apparatus 2 collects and transmits the apparatus information of its own apparatus. For example, the information processing apparatus 2 performs the collection of the backup target information of its own apparatus, the priority assignment, and the transmission. Additionally, the information processing apparatus 2 performs the reception of the execution instruction for the backup or restore.

The backup server 6 decides the priority for transferring the backup data on the basis of the backup priority for each apparatus and the apparatus information which are provided from the information processing apparatus 2 side and stores the backup data while following the transfer order set on the basis of this priority.

(16) According to the present embodiment, the data transfer amount at the time of the backup and restore is reduced, and it is possible to execute the maintenance operation without imposing a limitation on the time.

(17) According to the present embodiment, in accordance with the priority of the data to be backed up and the state of the monitoring apparatus, the backup is executed while taking into account the priority of the backup. With this configuration, even when the backup is not entirely completed, the effective data backed up in priority is restored, and the usability can be increased.

(18) According to the present embodiment, it is possible to disperse the stress in the network channel and the processing load that become adverse effects when the backup is executed via the network.

(19) When the backup restore function utilizing the network according to the present disclosure is mounted to the server apparatus or the like that constitutes the network system, the online backup function is enhanced with respect to the network type backup system in related art.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a backup data storage unit that stores backup data;
a monitoring information storage unit that stores monitoring information that includes at least identification information and priority information of the backup data; and
a backup data transfer unit that transfers the backup data to a backup server via a network in response to a transfer request for the backup data, the transfer request being received from the backup server on the basis of the priority information of the monitoring information which is notified to the backup server from the information processing apparatus.

2. The information processing apparatus according to claim 1, further comprising:
a function monitoring unit that monitors a function state of the information processing apparatus, wherein
the monitoring information includes failure information of the information processing apparatus obtained by the function monitoring unit.

3. The information processing apparatus according to claim 1, further comprising:
a recovery processing unit that reads out the backup data stored in the backup data storage unit or receives the backup data from the backup server to recover a function of the information processing apparatus, in response to a recovery instruction received from the backup server.

4. A backup server comprising:
a backup data storage unit that stores backup data transferred from an information processing apparatus via a network;
a monitoring information storage unit that stores monitoring information that includes an apparatus information for identifying the information processing apparatus and identification information and priority information of the backup data; and
a backup processing unit that generates transfer order information of the backup data on the basis of the monitoring information received from the information processing apparatus, transmits the transfer request for the backup data to the information processing apparatus on the basis of the transfer order information, and receives the backup data transferred from the information processing apparatus in response to the transfer request.

5. The backup server according to claim 4, wherein
the backup processing unit sets an apparatus priority to a plurality of information processing apparatuses connected to the backup server via the network and generates the transfer order information of the backup data on the basis of the apparatus priority and the priority of the backup data.

6. The backup server according to claim 4, wherein
the backup processing unit transmits a recovery instruction for reading out the backup data stored in the backup data storage unit of the information processing apparatus and recovering a function of the information processing apparatus to the information processing apparatus in a case where the monitoring information includes a failure information of the information processing apparatus.

7. The backup server according to claim 6, wherein
the backup processing unit transfers the backup data to the information processing apparatus and makes the function of the information processing apparatus recover in a case where the information processing apparatus determines not to perform a self-recovery.

8. A backup system comprising:
an information processing apparatus; and
a backup server, wherein
the information processing apparatus comprises:
a backup data storage unit that stores backup data;
a monitoring information storage unit that stores monitoring information that includes at least identification information and priority information of the backup data; and
a backup data transfer unit that transfers the backup data to the backup server via a network in response to a transfer request for the backup data, the transfer request being received from the backup server on the basis of the priority information of the monitoring information which is notified to the backup server from the information processing apparatus, and
the backup server comprises:
a backup data storage unit that stores the backup data transferred from the information processing apparatus via the network;
a monitoring information storage unit that stores monitoring information that includes apparatus information for identifying the information processing apparatus and identification information and priority information of the backup data; and
a backup processing unit that generates transfer order information of the backup data on the basis of the monitoring information received from the information processing apparatus, transmits the transfer request for the backup data to the information processing apparatus on the basis of the transfer order information, and receives the backup data transferred from the information processing apparatus in response to the transfer request.

9. The backup system according to claim 8, wherein
the information processing apparatus further comprises a function monitoring unit that monitors a function state of the information processing apparatus, and
the monitoring information includes a failure information of the information processing apparatus obtained by the function monitoring unit.

10. The backup system according to claim 8, wherein
the information processing apparatus further comprises a recovery processing unit that reads out the backup data stored in the backup data storage unit or receives the backup data from the backup server to recover a function of the information processing apparatus, in response to a recovery instruction received from the backup server.

11. The backup system according to claim 8, wherein
the backup processing unit sets an apparatus priority to a plurality of information processing apparatuses connected to the backup server via the network and generates the transfer order information of the backup data on the basis of the apparatus priority and the priority of the backup data.

12. The backup system according to claim 8, wherein
the backup processing unit transmits a recovery instruction to the information processing apparatus in a case where the monitoring information includes the failure information of the information processing apparatus, the recovery instruction includes an instruction of reading out the backup data stored in the backup data storage unit of the information processing apparatus and makes the function of the information processing apparatus recover.

13. The backup system according to claim 12, wherein
the backup processing unit transfers the backup data to the information processing apparatus and makes the function of the information processing apparatus recover in a case where the information processing apparatus determines not to perform a self-recovery.
